(19) United States
(12) Patent Application Publication
(10) Pub. No.: US 2024/0408861 A1
(43) Pub. Date: Dec. 12, 2024

(54) DECORATIVE SHEET, METHOD FOR PRODUCING DECORATIVE MOLDED ARTICLE, TRANSFER SHEET WITH MOLD RELEASE MEMBER, DECORATIVE SHEET WITH MOLD RELEASE MEMBER, TRANSFER SHEET PRECURSOR, DECORATIVE SHEET PRECURSOR, METHOD FOR PRODUCING TRANSFER SHEET, METHOD FOR PRODUCING DECORATIVE SHEET AND METHOD FOR PRODUCING DECORATIVE ARTICLE

(71) Applicant: DAI NIPPON PRINTING CO., LTD, Tokyo (JP)

(72) Inventors: Hiroto MATSUI, Tokyo (JP); Yoshimasa KOBAYASHI, Tokyo (JP)

(73) Assignee: DAI NIPPON PRINTING CO., LTD, Tokyo (JP)

(21) Appl. No.: 18/712,017

(22) PCT Filed: Nov. 24, 2022
(86) PCT No.: PCT/JP2022/043385

§ 371 Date: May 21, 2024

(30) Foreign Application Priority Data
Nov. 24, 2021 (JP) 2021-190261
Apr. 28, 2022 (JP) 2022-074490

(51) Int. Cl. B32B 37/26; B32B 7/06; B32B 27/06; B32B 37/12; B32B 38/00

(52) U.S. Cl. CPC B32B 37/26; B32B 7/06; B32B 27/06; B32B 37/12; B32B 38/145; B32B 2037/268; B32B 2307/4023; B32B 2307/54; B32B 2307/748; B32B 2451/00

(57) ABSTRACT

The present disclosure provides a decorative sheet and a method for producing a decorative molded article capable of producing a highly designed decorative molded article with a pattern printed by digital printing. The present disclosure provides a method for producing a decorative molded article comprising: a step of forming an image layer, by digital printing, on another surface of an elongation substrate provided with an adhesive layer and a peeling sheet on one surface; a step of forming a protective layer on the image layer to produce a decorative sheet wherein the peeling sheet, the adhesive layer, the elongation substrate, the image layer and the protective layer are stacked; and a step of removing the peeling sheet of the decorative sheet, and adhering the adhesive layer and a molded article to integrate the decorative sheet and the molded article.

### TECHNICAL FIELD

The present disclosure relates to a decorative sheet, a method for producing a decorative molded article, a transfer sheet with a mold release member, a decorative sheet with a mold release member, a transfer sheet precursor, a decorative sheet precursor, a method for producing a transfer sheet, a method for producing a decorative sheet and a method for producing a decorative article.

### BACKGROUND ART

An out-mold decoration is known as one of the methods of decoration on three-dimensional molded articles. For the property capable of retrofitting patterns, it is possible to develop a wide variety of small-lot products that meet diversifying consumer needs with the out-mold decoration. Also, it has a lower environmental impact than printing so that the out-mold decoration is more frequently employed increased in recent years.

The out-mold decoration is a molding method using a stretchable film, and gravure printing is mainly used for printing patterns. As described above, the out-mold decoration is a molding method suitable for a wide variety of small-lot products, whereas gravure printing is a method suitable for mass production, so that, depending on the quantity, it may not be profitable.

Digital printing methods such as an inkjet method, an electrophotography method, and a thermal transfer method are considered as printing methods suitable for a wide variety of small-lot products.

For example, Patent Documents 1 to 3 disclose a sheet including an image layer wherein the image is formed by an inkjet method, an electrophotography method, or a thermal transfer method.

### CITATION LIST

### Patent Documents

Patent Document 1: WO 2018/151257
Patent Document 2: Japanese Patent Application Laid-Open (JP-A) No. 2021-123031
Patent Document 3: JP-A No. 2020-163760

### SUMMARY OF DISCLOSURE

### Technical Problem

An object of the present disclosure is to provide a decorative sheet and a method for producing a decorative molded article capable of producing a highly designed decorative molded article with a pattern printed by digital printing.

### Solution to Problem

One embodiment of the present disclosure provides a method for producing a decorative molded article comprising: a step of forming an image layer, by digital printing, on another surface of an elongation substrate provided with an adhesive layer and a peeling sheet on one surface; a step of forming a protective layer on the image layer to produce a decorative sheet wherein the peeling sheet, the adhesive layer, the elongation substrate, the image layer and the protective layer are stacked; and a step of removing the peeling sheet of the decorative sheet, and adhering the adhesive layer and a molded article to integrate the decorative sheet and the molded article.

Another embodiment of the present disclosure provides a method for producing a decorative molded article comprising: a step of preparing an elongation substrate wherein a peeling sheet is provided on one surface and a mold release layer is provided on another surface; a step of forming a protective layer on the mold release layer; a step of forming an image layer, by digital printing, on the protective layer; a step of forming an adhesive layer on the image layer to produce a decorative sheet wherein the peeling sheet, the elongation substrate, the mold release layer, the protective layer, the image layer, and the adhesive layer are stacked; a step of removing the peeling sheet of the decorative sheet, and adhering the adhesive layer and a molded article to integrate the decorative sheet and the molded article; and a step of removing the elongation substrate and the mold release layer after integrating the decorative sheet and the molded article.

Another embodiment of the present disclosure provides a method for producing a decorative molded article comprising: a step of forming a protective layer on a substrate via a mold release layer; a step of forming an image layer, by digital printing, on the protective layer; a step of adhering the image layer of a stacked body wherein the substrate, the mold release layer, the protective layer and the image layer are stacked, on an elongation substrate via an adhesive layer; a step of removing the substrate and the mold release layer to produce a decorative sheet wherein the elongation substrate, the adhesive layer, the image layer and the protective layer are stacked; and a step of adhering the decorative sheet and a molded article to integrate the decorative sheet and the molded article.

Another embodiment of the present disclosure provides a method for producing a decorative molded article comprising: a step of stacking a first mold release layer and a first adhesive layer, in sequence, on a substrate; a step of forming an image layer, by digital printing, on the first adhesive layer; a step of preparing an elongation substrate wherein a second mold release layer and a protective layer are stacked on one surface in sequence, and adhering the image layer of a stacked body wherein the substrate, the first mold release layer, the first adhesive layer and the image layer are stacked, on the protective layer via a second adhesive layer; a step of removing the substrate and the first mold release layer to produce a decorative sheet wherein the elongation substrate, the second mold release layer, the protective layer, the second adhesive layer, the image layer and the first adhesive layer are stacked; and a step of adhering the first adhesive layer of the decorative sheet and a molded article, and removing the elongation substrate and the second mold release layer to integrate the decorative sheet and the molded article.

Another embodiment of the present disclosure provides a decorative sheet comprising: an elongation substrate; an adhesive layer and a peeling sheet stacked in sequence on one surface of the elongation substrate; an image layer including a digital print image provided on another surface of the elongation substrate; and a protective layer provided on the image layer, wherein the elongation substrate elongates 50% or more, when a tensile load of 0.05 N is applied at 90° C.

Another embodiment of the present disclosure provides a decorative sheet comprising: an elongation substrate; a peeling sheet provided on one surface of the elongation substrate; a mold release layer provided on another surface of the elongation substrate; a protective layer provided on the mold release layer; an image layer including a digital print image provided on the protective layer; and an adhesive layer provided on the image layer, wherein the elongation substrate elongates 50% or more, when a tensile load of 0.05 N is applied at 90° C.

Another embodiment of the present disclosure provides a decorative sheet comprising: an elongation substrate; an adhesive layer provided on the elongation substrate; an image layer including a digital print image provided on the adhesive layer; and a protective layer provided on the image layer, wherein the elongation substrate elongates 50% or more, when a tensile load of 0.05 N is applied at 90° C.

Another embodiment of the present disclosure provides a decorative sheet comprising: an elongation substrate; a mold release layer provided on one surface of the elongation substrate; a protective layer provided on the mold release layer; a first adhesive layer provided on the protective layer; an image layer, including a digital print image, provided on the first adhesive layer; and a second adhesive layer provided on the image layer, wherein the elongation substrate elongates 50% or more, when a tensile load of 0.05 N is applied at 90° C.

Another embodiment of the present disclosure provides a transfer sheet with a mold release member comprising a mold release member, a mold releasing support and a transfer layer in this order, wherein the transfer layer includes, in sequence from a mold releasing support side, a protective layer, an image layer including a thermal transfer image or a toner image, and a pressure-sensitive adhesive layer; and an elongation rate of the mold release member at 130° C. is lower than an elongation rate of the mold releasing support at 130° C.

Another embodiment of the present disclosure provides a decorative sheet with a mold release member comprising a mold release member, a substrate layer, an image layer including a thermal transfer image or a toner image, and a protective layer in this order, wherein an elongation rate of the mold release member at 130° C. is lower than an elongation rate of the substrate layer at 130° C.

Another embodiment of the present disclosure provides a transfer sheet precursor comprising a mold release member, a mold releasing support and a protective layer in this order, wherein an elongation rate of the mold release member at 130° C. is lower than an elongation rate of the mold releasing support at 130° C.

Another embodiment of the present disclosure provides a decorative sheet precursor comprising a mold release member and a substrate layer, wherein an elongation rate of the mold release member at 130° C. is lower than an elongation rate of the substrate layer at 130° C.

Another embodiment of the present disclosure provides a method for producing a transfer sheet comprising: a preparing step of preparing a stacked body for a transfer sheet including a mold release member, a mold releasing support and a protective layer in this order, and an elongation rate of the mold release member at 130° C. is lower than an elongation rate of the mold releasing support at 130° C.; an image layer forming step of forming an image layer, including a thermal transfer image or a toner image, on a protective layer side surface of the stacked body for a transfer sheet; and a pressure-sensitive adhesive layer placing step of placing a pressure-sensitive adhesive layer on the image layer, on a surface opposite side to the stacked body for a transfer sheet.

Another embodiment of the present disclosure provides a method for producing a decorative sheet comprising: a preparing step of preparing a stacked body for a decorative sheet including a mold release member and a substrate layer, and an elongation rate of the mold release member at 130° C. is lower than an elongation rate of the substrate layer at 130° C.; an image layer forming step of forming an image layer, including a thermal transfer image or a toner image, on a substrate layer side surface of the stacked body for a decorative sheet; a protective layer placing step of placing a protective layer on the image layer, on a surface opposite side to the stacked body for a decorative sheet; after the protective layer placing step, a peeling step of peeling the mold release member off from the stacked body for a decorative sheet; and after the peeling step, a pressure-sensitive adhesive layer placing step of placing a pressure-sensitive adhesive layer on the substrate layer, on a surface opposite side to the image layer.

Another embodiment of the present disclosure provides a method for producing a decorative article comprising: a transfer sheet with a mold release member producing step of producing a transfer sheet with a mold release member including a mold release member, a mold releasing support, a protective layer, an image layer including a thermal transfer image or a toner image, and a pressure-sensitive adhesive layer in this order, by the method for producing a transfer sheet described above; a peeling step of obtaining a transfer sheet by peeling the mold release member off from the transfer sheet with a mold release member; an integrating step of integrating the transfer sheet and a decorative object by placing so that a surface of the pressure-sensitive adhesive layer of the transfer sheet and the decorative object are facing each other; and after the integrating step, a transferring step of peeling the mold releasing support off from the transfer sheet.

Another embodiment of the present disclosure provides a method for producing a decorative article comprising: a decorative sheet producing step of producing a decorative sheet including a pressure-sensitive adhesive layer, a substrate layer, an image layer including a thermal transfer image or a toner image, and a protective layer in this order, by the method for producing a decorative sheet described above; and an integrating step of integrating the decorative sheet and a decorative object by placing so that a surface of the pressure-sensitive adhesive layer of the decorative sheet and the decorative object are facing each other.

### Advantageous Effects of Disclosure

According to the present disclosure, a highly designed decorative molded article with a pattern printed by digital printing may be produced.

### BRIEF DESCRIPTION OF DRAWINGS

FIG. 1 is a cross-sectional view illustrating a method for producing a decorative sheet in the present disclosure.

FIG. 2 is a cross-sectional view illustrating a method for producing a decorative sheet in the present disclosure.

FIG. 3 is a cross-sectional view of a decorative sheet in the present disclosure.

FIG. 4 is a cross-sectional view of a decorative molded article in the present disclosure.

FIG. 5 is a cross-sectional view illustrating a method for producing a decorative sheet in the present disclosure.

FIG. 6 is a cross-sectional view illustrating a method for producing a decorative sheet in the present disclosure.

FIG. 7 is a cross-sectional view of a decorative sheet in the present disclosure.

FIG. 8 is a cross-sectional view of a decorative molded article in the present disclosure.

FIG. 9 is a cross-sectional view of a decorative sheet in the present disclosure.

FIG. 10 is a cross-sectional view of a decorative molded article.

FIG. 11 is a cross-sectional view of a decorative sheet.

FIGS. 12A and 12B are cross-sectional views of a decorative molded article.

FIG. 13 is a schematic cross-sectional view illustrating an example of a transfer sheet with a mold release member in the present disclosure.

FIGS. 14A to 14D are process drawings illustrating an example of a method for producing a transfer sheet in the present disclosure.

FIGS. 15A to 15C are process drawings illustrating an example of a method for producing a decorative article in the present disclosure.

FIGS. 16A to 16B are process drawings illustrating an example of a method for producing a decorative article in the present disclosure.

FIG. 17 is a schematic cross-sectional view illustrating an example of a transfer sheet with a mold release member in the present disclosure.

FIG. 18 is a schematic cross-sectional view illustrating an example of a decorative sheet with a mold release member in the present disclosure.

FIGS. 19A to 19F are process drawings illustrating an example of a method for producing a decorative sheet in the present disclosure.

FIG. 20 is a schematic cross-sectional view illustrating an example of a decorative sheet with a mold release member in the present disclosure.

FIG. 21 is a schematic cross-sectional view illustrating an example of a transfer sheet precursor in the present disclosure.

FIGS. 22A and 22B are schematic cross-sectional views illustrating an example of a transfer sheet precursor in the present disclosure.

FIG. 23 is a schematic cross-sectional view illustrating an example of a decorative sheet precursor in the present disclosure.

FIGS. 24A and 24B are schematic cross-sectional views illustrating an example of a decorative sheet precursor in the present disclosure.

FIGS. 25A to 25C are process drawings illustrating an example of a method for producing a decorative article in the present disclosure.

FIGS. 26A to 26C are process drawings illustrating an example of a method for producing a transfer sheet.

FIGS. 27A to 27C are process drawings illustrating an example of a method for producing a decorative sheet.

### DESCRIPTION OF EMBODIMENTS

Embodiments in the present disclosure are hereinafter explained with reference to, for example, drawings. However, the present disclosure is enforceable in a variety of different forms, and thus should not be taken as is limited to the contents described in the embodiments exemplified as below. Also, the drawings may show the features of the present disclosure such as width, thickness, and shape of each part schematically comparing to the actual form in order to explain the present disclosure more clearly in some cases; however, it is merely an example, and thus does not limit the interpretation of the present disclosure. Also, in the present descriptions and each drawing, for the factor same as that described in the figure already explained, the same reference sign is indicated and the detailed explanation thereof may be omitted.

In the present descriptions, in expressing an aspect wherein some member is placed on the other member, when described as merely “on” or “below”, unless otherwise stated, it includes both of the following cases: a case wherein some member is placed directly on or directly below the other member so as to be in contact with the other member, and a case wherein some member is placed on the upper side or the lower side of the other member via yet another member. Also, in the present descriptions, on the occasion of expressing an aspect wherein some member is placed on the surface of the other member, when described as merely “on the surface side” or “on the surface”, unless otherwise stated, it includes both of the following cases: a case wherein some member is placed directly on or directly below the other member so as to be in contact with the other member, and a case wherein some member is placed on the upper side or the lower side of the other member via yet another member.

Also, in the present descriptions, a member referred to as “film” is included in “sheet”.

A decorative sheet, a method for producing a decorative molded article, a transfer sheet with a mold release member, a decorative sheet with a mold release member, a transfer sheet precursor, a decorative sheet precursor, a method for producing a transfer sheet, a method for producing a decorative sheet and a method for producing a decorative article in the present disclosure will be hereinafter described in detail.

### (I) Decorative Sheet and Method for Producing Decorative Molded Article

A method for producing a decorative molded article according to an embodiment of the present disclosure is a method wherein a decorative sheet including a digital print image is produced, and this decorative sheet is adhered to a molded article by, for example, an out-mold decoration.

### A. Decorative Sheet and Method for Producing Decorative Molded Article of First Embodiment

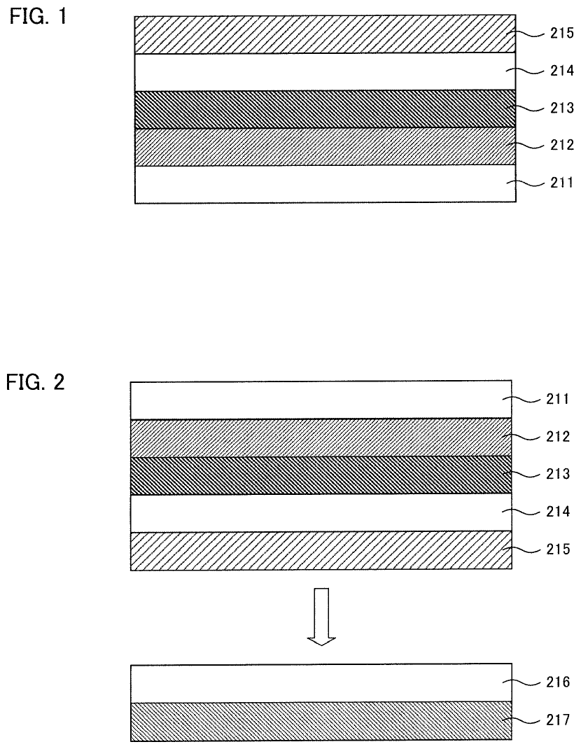

A method for producing a decorative sheet according to the first embodiment will be described. As shown in FIG. 1, a mold release layer 212 and a protective layer 213 are formed on one surface of a substrate 211 in sequence.

The material of the substrate 211 is not particularly limited, and examples may include oriented or cast plastic films such as highly heat-resistant polyesters such as polyethylene terephthalate, polyethylene naphthalate, polybutylene terephthalate, polyphenylene sulfide, polyetherketone or polyethersulfone; polypropylene; polycarbonate; cellulose acetate; polyethylene derivatives; polyvinyl chloride; polyvinylidene chloride; polystyrene; polyamide; polyimide; polymethylpentene or ionomer. Also, a composite film wherein two kinds or more of these materials are stacked, may be used. The thickness of the substrate 211 is not particularly limited, and it is preferably in a range of 25 μm or more and 1000 μm or less. By setting the elongation of the substrate 211, when a tensile load of 150 N is applied at 150° C., to 20% or less, the substrate may be prevented from being stretched by the heat during the printing in the image printing described later.

A separation substrate for adjusting the thickness may be provided on the other surface of the substrate 211.

Examples of the material of the mold release layer 212 may include silicone mold releasing agents and fluorine based mold releasing agents. The thickness of the mold release layer 212 is not particularly limited, and one example is 0.1 μm or more and 5.0 μm or less.

The protective layer 213 is a layer configured to protect the image of the image layer 214 described later, and a known transparent resin material may be used. The transparent resin material may be curable resin, and may be non-curable resin. Examples of the curable resin may include curable resins such as ionizing radiation curable resins and thermosetting resins. The ionizing radiation is described in the section “(II) A. Transfer sheet with mold release member” later. The curable resins are preferably ionizing radiation curable resins, and ultraviolet curable resins are more preferable. When the protective layer includes the curable resin, the protective layer 213 may be an uncured layer. Also, the protective layer 213 may be an uncured hard coating layer. Meanwhile, non-curable resin means resin not cured by irradiation of ionizing radiation or by heating. Examples of the non-curable resin may include acrylic resins. The acrylic resins are similar to the acrylic resins used for the protective layer, for example, those described in WO 2020/067272. Above all, the protective layer preferably includes the non-curable resin, and more preferably includes the acrylic resins. The thickness of the protective layer 213 is not particularly limited, and for example, it is 0.1 μm or more and 5.0 μm or less.

The protective layer 213 may include a layer including transparent resin material, and a primer layer including an ultraviolet absorber, provided on the layer including transparent resin material. Also, the protective layer 213 may include an uncured hard coating layer, and a primer layer including an ultraviolet absorber, provided on the hard coating layer. In order to suppress the diffusion of dye from the receptor layer described later, the primer layer is required to have a heat resistance, and the glass transition temperature thereof is preferably 150° C. or more.

Then, using a known digital printing method printer such as thermal transfer printer, inkjet printer, laser printer, and LED printer, an image layer 214 is formed on the protective layer 213. Examples of the digital printing method may include a thermal transfer method, an inkjet method, and an electrophotography method. Examples of the electrophotography method may include a laser method, and a LED (light emitting diode) method. When the image layer is formed by the digital printing method, an image layer including a digital print image is obtained. In the case of the thermal transfer method, an image layer including a thermal transfer image is obtained. In the case of the electrophotography method, an image layer including a toner image is obtained. In the case of the inkjet method, an image layer including an ink image is obtained. The thermal transfer method enables printing of, for example, a metallic or pearl tone pattern, and it is suitable for the production of a highly designed decorative article. Among the above, the thermal transfer method is preferable.

In the case of the thermal transfer method, the image layer 214 is formed, for example, by forming a receptor layer on the protective layer 213, and printing an image on the receptor layer using a sublimation transfer method. The sublimation transfer method is an image forming method using a thermal transfer sheet provided with a color material layer including sublimation dye wherein thermal energy according to the image information is applied to the thermal transfer sheet, and an image is formed by transferring the sublimation dye, included in the color material layer, to the receptor layer. The sublimation dyes are, for example, yellow dyes, magenta dyes, cyan dyes, and fluorescent dyes. The method for forming the receptor layer is similar to the method for forming a receptor layer described in the section “(II) E. Method for producing transfer sheet, 2. Image forming step” below.

In the case of the thermal transfer method, the image layer 214 may be formed by a melting transfer method. The melting transfer method is an image forming method using a thermal transfer sheet provided with a color material layer including melting ink, and thermal energy according to the image information is applied to the thermal transfer sheet, and the image layer is formed by transferring the melt or softened color material layer, onto the protective layer 213, as a whole layer, by an application of thermal energy. The melting inks are colorants such as black pigments, metallic pigments, pearl pigments, and fluorescent pigments. The melting ink may be a decorative layer including a hologram, for example.

The image layer 214 may be one including a first image layer by the sublimation transfer method, and a second image layer formed on the first image layer by the melting transfer method.

In the case of the inkjet method, the image layer 214 includes ink. The ink includes at least a colorant and a resin component. Examples of the colorant may include pigments and dyes. The color of the colorant is not particularly limited. General inkjet inks may be used as the ink.

In the case of the electrophotography method, the image layer 214 includes toner. The toner includes, for example, resin components, pigments, charge control agents, and wax. The color of the pigment is not particularly limited. General toner may be used as the toner.

The thickness of image layer 214 is not particularly limited, and for example, it is 0.1 μm or more and 5.0 μm or less.

A second adhesive layer 215 is formed on the image layer 214. The second adhesive layer 215 is an adhesive layer or a pressure-sensitive adhesive layer. Examples of the material of the adhesive layer may include cellulose derivatives such as ethyl cellulose, and cellulose acetate butyrate; styrene copolymers such as polystyrene, and polyα-methylstyrene; acrylic resins such as polymethylmethacrylate, polyethylmethacrylate, and polyethylacrylate; vinyl resins such as polyvinyl chloride, polyvinyl acetate, vinyl chloride-vinyl acetate copolymer, and polyvinyl butyral; polyester; nylon resins; epoxy resins; and polyurethane.

For the resins for the pressure-sensitive adhesive layer, commonly used acrylic based resins, urethane based resins, polyester based resins, silicone based resins, vinyl chloride based resins or vinyl acetate based resins, or mixtures or copolymers of two kinds or more of these may be used.

The thickness of second adhesive layer 215 is not particularly limited, and for example, it is 0.1 μm or more and 5.0 μm or less. The method for placing the second adhesive layer 215 on the image layer 214 is similar to the method for placing the pressure-sensitive adhesive layer described in the section “(II) E. Method for producing transfer sheet, 3. Pressure-sensitive adhesive layer placing step” below. Among them, the transfer method is preferable from the viewpoint of handling capability. Also, when the image layer is formed by the thermal transfer method and the pressure-sensitive adhesive layer is transferred, the pressure-sensitive adhesive layer may also be thermally transferred at the time of forming the thermal transfer image by using a thermal transfer sheet including a color material layer and a pressure-sensitive adhesive layer; or the pressure-sensitive adhesive layer may be thermally transferred onto the image layer by using a transfer sheet including a pressure-sensitive adhesive layer.

Then, as shown in FIG. 2, the second adhesive layer 215 of the stacked body including a substrate 211, a mold release layer 212, a protective layer 213, an image layer 214 and a second adhesive layer 215 is adhered to one surface of the elongation substrate 216. A first adhesive layer 217 is provided on the other surface of the elongation substrate 216. Incidentally, when the second adhesive layer 215 is a pressure-sensitive adhesive layer, the second adhesive layer 215 may be placed on one surface of the elongation substrate 216 instead of on the image layer 214.

Incidentally, in the section “(I) Decorative sheet and method for producing decorative molded article”, the adhesive layer for adhering the decorative sheet and molded article is referred to as the “first adhesive layer”, and the adhesive layer for adhering each layer constituting the decorative sheet is referred to as the “second adhesive layer”.

When the decorative molding step described later is an out-mold decoration, the material of the elongation substrate 216 is, for example, polyvinyl chloride, glycol-modified polyethylene terephthalate, polyolefin, polyurethane, and polyurethane plastic elastomer. The thickness of the elongation substrate 216 is approximately 25 μm or more and 1000 μm or less. Also, the elongation substrate 216 preferably elongates 50% or more, when a tensile load of 0.05 N is applied at 90° C.

Here, the elongation rate of the elongation substrate 216 at 90° C. may be measured by a test method compliant to JIS K7127:1999. Specifically, using a tensile tester, a test piece is pulled at a temperature of 90° C. and at a speed of 200 mm/minute, compliant to JIS K7127:1999. In this tensile test, when the elongation rate of the elongation substrate, when a tensile load is 0.05 N, is 50% or more, it can be said that the elongation substrate elongates 50% or more when the tensile load of 0.05N is applied at 90° C. As the tensile tester, for example, a tensilon universal material testing instrument may be used. The elongation rate is calculated by the following formula.

Elongation rate (%)=100×(L₂−L₁)/L₁ (1).

(In the above formula, L₁ is the length of the test piece before the tensile test and L₂ is the length of the test piece at the time of the tensile test.)

The first adhesive layer 217 is an adhesive layer or a pressure-sensitive adhesive layer. The material of the adhesive layer and the resin of the pressure-sensitive adhesive layer may be similar to the second adhesive layer 215 described above. The thickness of first adhesive layer 217 is not particularly limited, and for example, it is 1 μm or more and 3000 μm or less. A peeling sheet may be provided on the first adhesive layer 217, on the surface opposite side to the elongation substrate 216.

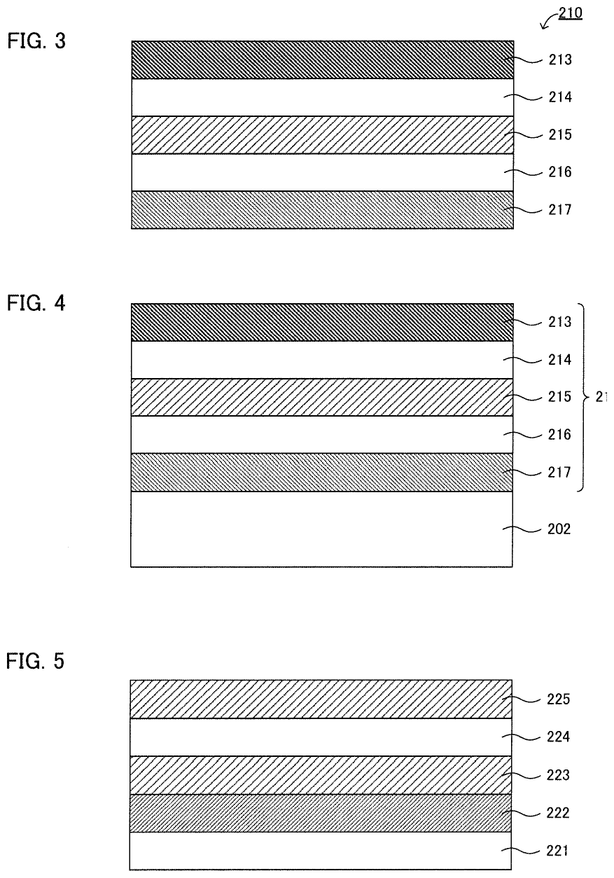

Then, as shown in FIG. 3, by peeling the substrate 211 and mold release layer 212 off, a decorative sheet 210 wherein a first adhesive layer 217, an elongation substrate 216, a second adhesive layer 215, an image layer 214, and a protective layer 213 are stacked in sequence, is obtained.

As shown in FIG. 4, the first adhesive layer 217 of the decorative sheet 210 and a molded article 202 are adhered to integrate the decorative sheet 210 and the molded article 202. The shape and material of the molded article 202 is not particularly limited; it may be formed of resin, and may be formed of metal. This decorative molding step is preferably an out-mold decoration, above all, a vacuum molding, especially TOM (three-dimension overlay method) molding is preferable.

In the vacuum molding, the molded article 202 is set on a table in the chamber box of the vacuum molding device, and the decorative sheet 210 is set above the molded article 202. While creating a vacuum condition in the chamber box, the decorative sheet 210 is heated with a heater. The heated decorative sheet 210 softens and hangs down due to its own weight. The decorative sheet 210 may be closely adhered to the molded article 202, and may be molded by raising the table so that only the region above the decorative sheet 210 of the chamber box is at atmospheric pressure. When the protective layer includes curable resin, after the decorative molding step, the protective layer 213 is cured by exposing thereof to ionizing radiation such as ultraviolet rays, and electron beam, or by heating.

As described above, a highly designed decorative molded article with a pattern (image) printed by digital printing may be produced. Also, in the case of the thermal transfer method or the electrophotography method, since the elongation substrate 216 is adhered after the formation of the image layer 214 in the present embodiment, the stretching of the elongation substrate 216, by the heat at the time of the image layer formation, may be suppressed.

In the embodiment described above, an anchor layer including an ultraviolet absorber may be provided on the elongation substrate 216 before adhering the stacked body of substrate 211, mold release layer 212, protective layer 213, image layer 214 and second adhesive layer 215. The anchor layer improves the adhesion between the elongation substrate 216 and the second adhesive layer 215; and polyurethane, polyolefin, polyester, (meth) acrylic resins, epoxy resins, urea resins, melamine resins, phenolic resins, vinyl resins and cyanoacrylate resins may be used. When the molded article 202 is transparent, the image deterioration of the image layer 214 may be suppressed by providing an anchor layer between the elongation substrate 216 and the second adhesive layer 215.

### B. Decorative Sheet and Method for Producing Decorative Molded Article of Second Embodiment

A method for producing a decorative sheet according to the second embodiment will be described. As shown in FIG. 5, a first mold release layer 222, a first adhesive layer 223, an image layer 224, and a second adhesive layer 225 are formed on a substrate 221 in sequence. The substrate 221 is similar to the substrate 211 described above. The first mold release layer 222 may be similar to the mold release layer 212 described above. The first adhesive layer 223 and the second adhesive layer 225 may be similar to the second adhesive layer 215 described above. The image layer 224 is formed on the first adhesive layer 223 before the formation of the second adhesive layer 225, and may be similar to the image layer 214 described above.

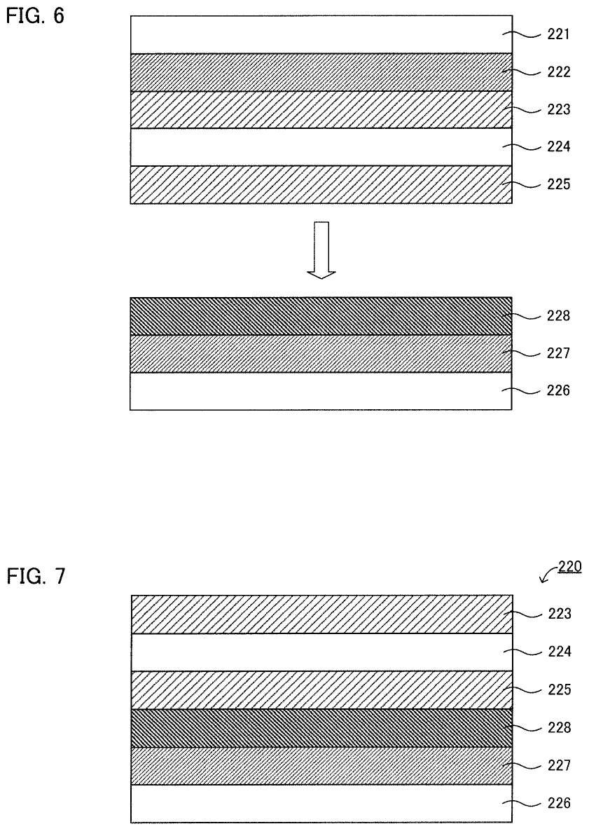

As shown in FIG. 6, a second mold release layer 227 and a protective layer 228 are formed on an elongation substrate 226 in sequence. The second mold release layer 227 and the protective layer 228 may be similar to the mold release layer 212 and the protective layer 213 described above.

When the decorative molding step described below is an out-mold decoration, one similar to the elongation substrate 216 described above may be used as the elongation substrate 226.

Onto the protective layer 228, the second adhesive layer 225 of a stacked body of a substrate 221, a first mold release layer 222, a first adhesive layer 223, an image layer 224, and a second adhesive layer 225, is adhered.

Then, as shown in FIG. 7, by peeling the substrate 221 and first mold release layer 222 off, a decorative sheet 220 wherein an elongation substrate 226, a second mold release layer 227, a protective layer 228, a second adhesive layer 225, an image layer 224, and a first adhesive layer 223 are stacked in sequence is obtained.

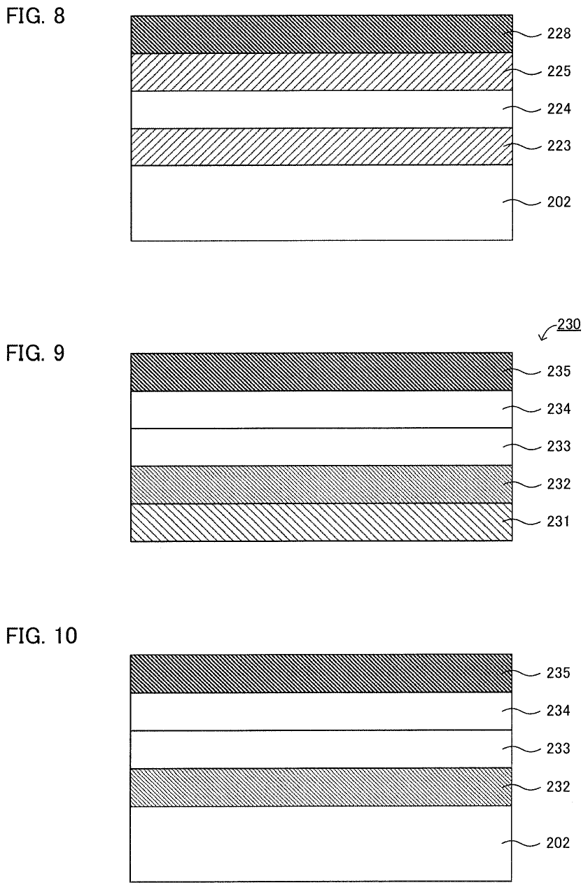

As shown in FIG. 8, the first adhesive layer 223 of the decorative sheet 220 and a molded article 202 are adhered, the elongation substrate 226 and the second mold release layer 227 are peeled off, and the decorative sheet 220 and the molded article 202 are integrated by, for example, an out-mold decoration. Thereby, a highly designed decorative molded article with a pattern (image) printed by digital printing may be produced. Also, in the case of the thermal transfer method or the electrophotography method, since the elongation substrate 226 is adhered after the formation of the image layer 224 as similar to the first embodiment described above, the stretching of the elongation substrate 226, by the heat at the time of the image layer formation, may be suppressed.

An anchor layer including an ultraviolet absorber may be provided on the protective layer 228. The anchor layer improves adhesion between the protective layer 228 and the second adhesive layer 225. The material of the anchor layer is similar to those described above. Also, a primer layer including an ultraviolet absorber may be provided between the first adhesive layer 223 and the image layer 224. The image deterioration may be suppressed by sandwiching the image layer 224 with the anchor layer and the primer layer.

### C. Decorative Sheet and Method for Producing Decorative Molded Article of Third Embodiment

As shown in FIG. 9, an adhesive layer 232 and a peeling sheet 231 are provided on one surface of an elongation substrate 233 in sequence. The elongation substrate 233 and the adhesive layer 232 may be similar to the elongation substrate 216 and the first adhesive layer 217 described above.

As the peeling sheet 231, for example, paper, processed paper, synthetic paper, and plastic film may be used. The peeling sheet 231 is preferably less likely to be stretched by the heat. The material and elongation of the plastic film are similar to the material and elongation of the substrate 211 described above. Also, the plastic film may be a porous resin film such as a porous polyethylene terephthalate film.

Then, an image layer 234 and a protective layer 235 are formed on the other surface of the elongation substrate 233 in sequence. The image layer 234 and the protective layer 235 may be similar to the image layer 214 and the protective layer 213 described above. Thereby, a decorative sheet 230 wherein a peeling sheet 231, an adhesive layer 232, an elongation substrate 233, an image layer 234, and a protective layer 235 are stacked in sequence is obtained.

As shown in FIG. 10, the peeling sheet 231 of the decorative sheet 230 are peeled off, the adhesive layer 232 and a molded article 202 are adhered, and the decorative sheet 230 and the molded article 202 are integrated by, for example, an out-mold decoration. Thereby, a highly designed decorative molded article with a pattern (image) printed by digital printing may be produced.

In the case of the thermal transfer method or the electrophotography method, since the adhesive layer 232 and the peeling sheet 231 are provided on one surface of the elongation substrate 233 in the present embodiment, the stretching of the elongation substrate 233, by the heat at the time of forming the image layer 234 on the other surface, may be suppressed.

### D. Decorative Sheet and Method for Producing Decorative Molded Article of Fourth Embodiment

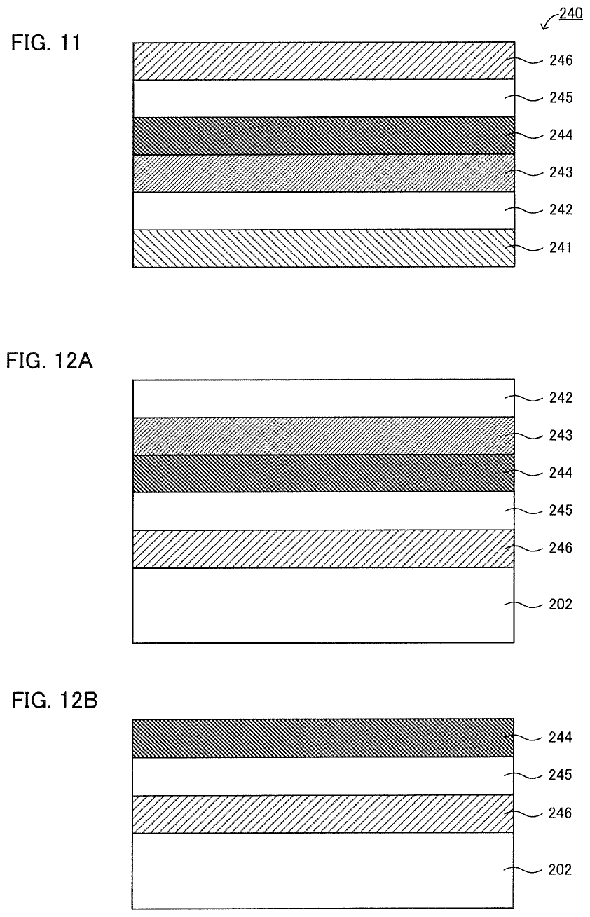

As shown in FIG. 11, a peeling sheet 241 is provided on one surface of an elongation substrate 242, and a mold release layer 243 and a protective layer 244 are provided on the other surface. The peeling sheet 241, the elongation substrate 242, the mold release layer 243 and the protective layer 244 may be similar to the peeling sheet 231, the elongation substrate 216, the mold release layer 212 and the protective layer 213 described above.

Then, an image layer 245 and an adhesive layer 246 are formed on the protective layer 244 in sequence. The image layer 245 and the adhesive layer 246 may be similar to the image layer 214 and the second adhesive layer 215 described above. Thereby, a decorative sheet 240 wherein a peeling sheet 241, an elongation substrate 242, a mold release layer 243, a protective layer 244, an image layer 245, and an adhesive layer 246 are stacked in sequence, is obtained.

As shown in FIG. 12A, the peeling sheet 241 of the decorative sheet 240 is peeled off, and the adhesive layer 246 and a molded article 202 are adhered to integrate the decorative sheet 240 and the molded article 202 by, for example, an out-mold decoration, and then, as shown in FIG. 12B, the elongation substrate 242 and the mold release layer 243 are peeled off. Thereby, a highly designed decorative molded article with a pattern (image) printed by digital printing may be produced.

Also, although not shown in the figures, the decorative sheet 240 and the molded article 202 may be integrated, for example, by an out-mold decoration, by adhering the adhesive layer 246 of the decorative sheet 240 and a molded article 202, and peeling the peeling sheet 241, the elongation substrate 242 and the mold release layer 243 off.

In the case of the thermal transfer method or the electrophotography method, since the peeling sheet 241 is provided on one surface of the elongation substrate 242, the stretching of the elongation substrate 242, by the heat at the time of forming the image layer 245 on the other surface side, may be suppressed.

(II) Transfer sheet with mold release member, decorative sheet with mold release member, transfer sheet precursor, decorative sheet precursor, method for producing transfer sheet, method for producing decorative sheet and method for producing decorative article

Conventionally, decorative articles wherein the surface of decorative objects are decorated with sheets, have been used for various purposes. The methods for producing a decorative article are roughly classified into two types: a primary decoration wherein a decoration is carried out at the same time as molding, and a secondary decoration wherein a decoration is carried out after molding. Also, the method for producing a decorative article includes a method wherein a sheet is adhered, and a method wherein a sheet is transferred.

For example, in-mold decoration and insert molding are known as the primary decoration. Also, for example, three-dimensional surface decoration, so-called TOM method (three-dimension overlay method) is known as the secondary decoration.

Also, as a sheet used for the decoration, a sheet, including an image layer wherein an image is formed, is known. Examples of the method for forming an image may include a printing method. The printing method may be broadly classified into two types: a with-plate printing method and a plate-less printing method. The plate-less printing method is also referred to as digital printing. In particular, the plate-less printing method has an advantage that on-demand printing is possible. Also, examples of the plate-less printing method may include an inkjet method, an electrophotography method, and a thermal transfer method. In particular, the thermal transfer method is used in various fields because of its simple imaging principle and it is capable of realizing a smaller size and lower cost.

Examples of the thermal transfer method may include a sublimation type thermal transfer method and a melting type thermal transfer method. Both thermal transfer methods are a method wherein an image is formed using a thermal head. Therefore, when the image is formed by the thermal transfer method, heat and pressure are applied to the printing object by the thermal head during the image formation.

Also, in the electrophotography method, in order to fix the toner adhered to a drum, heat and pressure are applied to the printing object by the drum.

By the way, the sheets used in the method for producing a decorative article described above are required to be stretchable. Therefore, when an image is formed by the thermal transfer method, the sheet may be stretched by the heat and pressure of the thermal head during the image formation. Also, when the image is formed by the electrophotography method, the sheet may be stretched due to heat and pressure from the drum during the image formation. This leads to a problem that print wrinkles and print unevenness are induced, which leads to an appearance defect.

Also, in the sheets used in the method for producing a decorative article described above, a pressure-sensitive adhesive layer may be provided in the sheet, in some cases, to adhere the sheet and the decorative object. When an image is formed by the thermal transfer method, if the sheet includes a relatively soft layer such as a pressure-sensitive adhesive layer, the image may crack due to the heat and pressure of the thermal head during the image formation, and may cause an appearance defect. Also, when an image is formed by the electrophotography method, the image may crack due to heat and pressure from the drum during the image formation, and may cause an appearance defect.

The second object of the present disclosure is to provide a transfer sheet and a decorative sheet capable of suppressing an appearance defect.

A. Transfer Sheet with Mold Release Member

The transfer sheet with a mold release member in the present disclosure comprises a mold release member, a mold releasing support and a transfer layer in this order, wherein the transfer layer includes, in sequence from a mold releasing support side, a protective layer, an image layer including a thermal transfer image or a toner image, and a pressure-sensitive adhesive layer; and an elongation rate of the mold release member at 130° C. is lower than an elongation rate of the mold releasing support at 130° C.

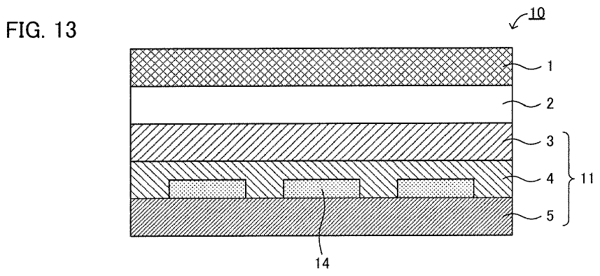

FIG. 13 is a schematic cross-sectional view illustrating an example of a transfer sheet with a mold release member in the present disclosure. As shown in FIG. 13, a transfer sheet with a mold release member 10 comprises a mold release member 1, a mold releasing support 2 and a transfer layer 11 in this order, and the transfer layer 11 includes, in sequence from a mold releasing support 2 side, a protective layer 3, an image layer 4 including a thermal transfer image 14, and a pressure-sensitive adhesive layer 5. In the transfer sheet with a mold release member 10, the elongation rate of the mold release member 1 at 130° C. is lower than the elongation rate of the mold releasing support 2 at 130° C.

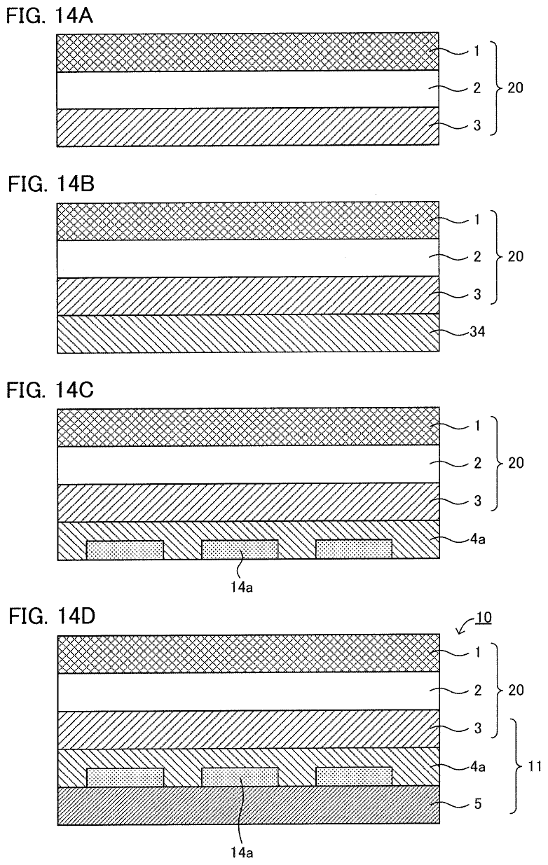

FIGS. 14A to 14D are process drawings illustrating an example of a method for producing a transfer sheet in the present disclosure, and the example is an example wherein the thermal transfer image is formed by a sublimation type thermal transfer method. Firstly, as shown in FIG. 14A, a stacked body for a transfer sheet 20 includes a mold release member 1, a mold releasing support 2 and a protective layer 3 in this order, is prepared. Then, as shown in FIG. 14B, a receptor layer 34 is formed on the protective layer 3 side surface of the stacked body for a transfer sheet 20. Then, as shown in FIG. 14C, a thermal transfer image 14a is formed on the receptor layer 34 by a sublimation type thermal transfer method. Thereby, an image layer 4a including a thermal transfer image 14a is obtained. Then, as shown in FIG. 14D, a pressure-sensitive adhesive layer 5 is placed on the image layer 4a, on the surface opposite side to the stacked body for a transfer sheet 20.

In the transfer sheet with a mold release member in the present disclosure, since the mold release member, the mold releasing support, and the transfer layer are placed in this order, as shown in FIG. 14C for example, when the thermal transfer image is formed, the mold releasing support is supported by the mold release member. Since the elongation rate of the mold release member at 130° C. is lower than the elongation rate of the mold releasing support at 130° C., the mold releasing support may be prevented from being stretched, by the heat and pressure of the thermal head, during the formation of the thermal transfer image. Therefore, it is possible to suppress the print wrinkles and print unevenness due to the stretch of the mold releasing support.

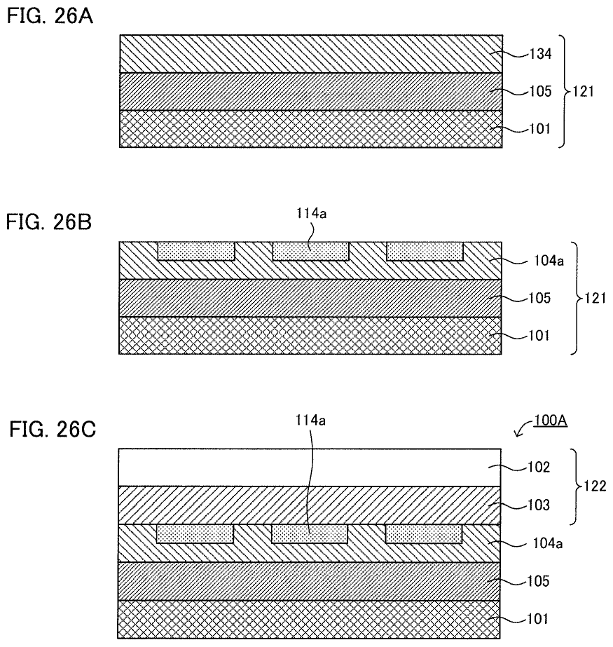

Here, FIGS. 26A to 26C are process drawings illustrating an example of a method for producing a transfer sheet not according to the present embodiment, and the example is an example wherein the thermal transfer image is formed by a sublimation type thermal transfer method. Firstly, as shown in FIG. 26 (A), a stacked body 121 including a separator 101, a pressure-sensitive adhesive layer 105 and a receptor layer 134, is prepared. Then, as shown in FIG. 26B, a thermal transfer image 114a is formed on the receptor layer 134 by sublimation type thermal transfer method. Thereby, an image layer 104a including a thermal transfer image 114a is obtained. Then, as shown in FIG. 26C, a stacked body 122 including a mold releasing support 102, and a protective layer 103 is placed on the image layer 104a, on the surface opposite side to the pressure-sensitive adhesive layer 105. Thereby, a transfer sheet 100A is obtained.

In the method for producing a transfer sheet shown in FIGS. 26A to 26C, when the thermal transfer image is formed, the pressure-sensitive adhesive layer 105 exists in the stacked body 121. When the stacked body 121 includes a relatively soft layer such as the pressure-sensitive adhesive layer 105, the image may crack due to the heat and pressure of the thermal head during the image formation when the thermal transfer image is formed, and may cause an appearance defect.

In contrast to this, in the transfer sheet with a mold release member in the present disclosure, since the mold release member, the mold releasing support, and the transfer layer are placed in this order, and since the transfer layer includes, in sequence from a mold releasing support side, a protective layer, an image layer including a thermal transfer image, and a pressure-sensitive adhesive layer, as shown in FIG. 14C for example, when the thermal transfer image is formed, the pressure-sensitive adhesive layer does not exist in the stacked body for a transfer sheet. Therefore, the thermal transfer image may be prevented from being cracked, by the heat and pressure of the thermal head, during the formation of the thermal transfer image.

Incidentally, in the method for producing a transfer sheet shown in FIGS. 26A to 26C, the reason why the pressure-sensitive adhesive layer 105 is placed in the stacked body 121 prior to the formation of the thermal transfer image is to make the separator 101 to be the only one member peeled off prior to the integration of the transfer sheet and the decorative object. This reduces the number of processes and production costs. This separator 101 is a member configured to protect the pressure-sensitive adhesive layer 105.

Meanwhile, although not shown in the method for producing a transfer sheet in the present disclosure as shown in FIGS. 14A to 14D, in order to protect the pressure-sensitive adhesive layer 5, when the separator is placed on the pressure-sensitive adhesive layer 5, on the surface opposite side to the image layer 4a, the two members peeled off before the transfer sheet and the decorative object are integrated are the mold release member 1 and the separator. In the present disclosure, although the number of members peeled off before the transfer sheet and the decorative object are integrated increases, the cracking of the thermal transfer image may be suppressed.

In the example above, the case wherein the thermal transfer image is formed by a thermal transfer method, was described, and similarly in a case wherein a toner image is formed by an electrophotography method, the toner image may be suppressed from being cracked due to the heat and pressure of the drum during the formation of the toner image.

Also, the transfer sheet with the mold release member in the present disclosure is used for decoration by the transfer method. In the transfer sheet with a mold release member, the members from the pressure-sensitive adhesive layer to the protective layer are the transfer layers.

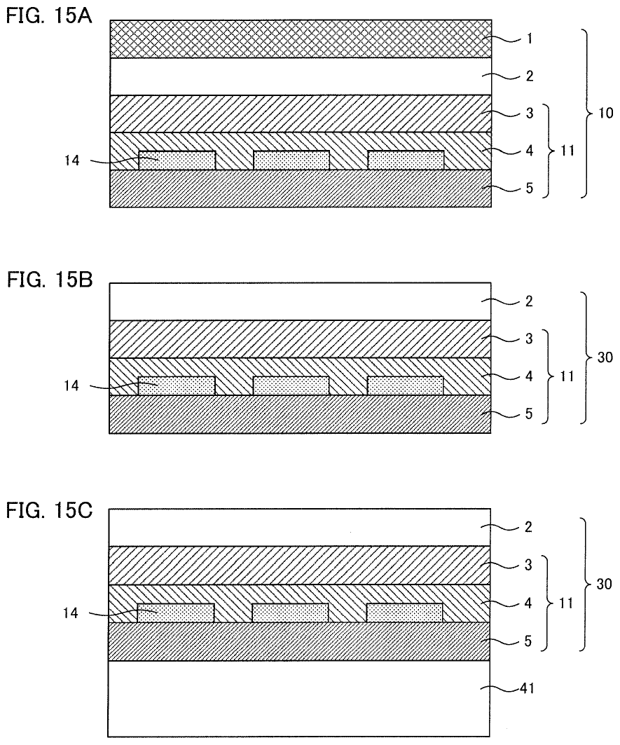

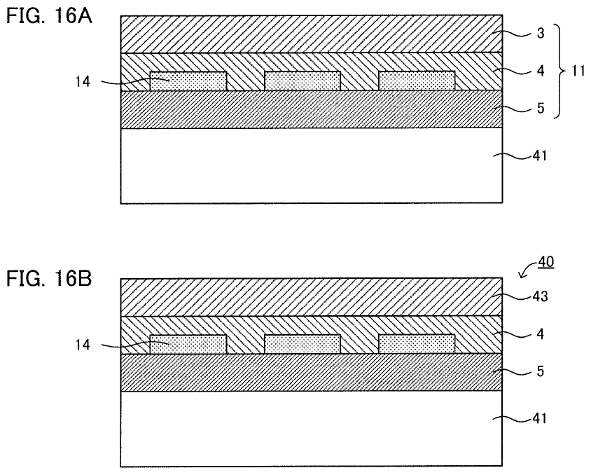

FIGS. 15A to 15C and FIGS. 16A and 16B are process drawings illustrating an example of a method for producing a decorative article using the transfer sheet with a mold release member in the present disclosure. Firstly, as shown in FIG. 15A, a transfer sheet with a mold release member 10 is prepared. The transfer sheet with a mold release member 10 is similar to the transfer sheet with a mold release member 10 shown in FIG. 1. Then, as shown in FIGS. 15A and 15B, a transfer sheet 30, after the mold release member has been peeled off, is obtained by peeling the mold release member 1 off from the transfer sheet with a mold release member 10. Then, as shown in FIG. 15C, the transfer sheet 30 and the decorative object 41 are integrated. Then, as shown in FIGS. 15C to 16A, the mold releasing support 2 is peeled off from the transfer sheet 30, and the transfer layer 11 is transferred to the decorative object 41. After that, when the protective layer 3 includes curable resin composition, as shown in FIGS. 16A and 16B, the protective layer 3 is cured to form a cured protective layer 43. In doing so, when the pressure-sensitive adhesive layer 5 is a curable pressure-sensitive adhesive layer, the pressure-sensitive adhesive layer 5 may be cured. Thereby, a decorative article 40 is obtained.

In the transfer sheet with a mold release member in the present disclosure, since the mold releasing support is supported by the mold release member when the thermal transfer image or the toner image is formed, the mold releasing support may be suppressed from being stretched; whereas, since the mold release member is peeled off when the decorative object is decorated, the elongation of the transfer sheet after the mold release member has been peeled off may be improved so that the molding ability of the transfer sheet may be improved.

Therefore, according to the transfer sheet with a mold release member in the present disclosure, an appearance defect may be suppressed.

Here, the TOM method, one of the secondary decorations, is advantageous such that it may be used for all types of decorative object material. Meanwhile, in the TOM method, the thickness of the pressure-sensitive adhesive layer is likely to be made relatively thick, in order to adhere the transfer sheet or decorative sheet with the decorative object. When the thickness of the pressure-sensitive adhesive layer is thick, a crack in the thermal transfer image or the toner image described above is likely to occur. Therefore, when the transfer sheet is used to decorate the decorative object by the TOM method, the transfer sheet with a mold release member in the present disclosure is useful.

Also, in the transfer sheet with a mold release member in the present disclosure, since the image layer includes a thermal transfer image or a toner image, on-demand printing is possible so that it is suitable for a small-lot, a wide variety, and a short delivery time production.

The transfer sheet with mold release member in the present disclosure corresponds to the decorative sheet in the fourth embodiment described above, except for the elongation rate of the mold releasing support at 130° C. Specifically, the mold release member 1, mold releasing support 2, mold release layer 8, protective layer 3, image layer 4 and pressure-sensitive adhesive layer 5 in the transfer sheet with a mold release member respectively correspond to the peeling sheet 241, elongation substrate 242, mold release layer 243, protective layer 244, image layer 245 and adhesive layer 246 in the decorative sheet in the fourth embodiment described above.

Each constitution of the transfer sheet with a mold release member in the present disclosure is hereinafter described.

### 1. Mold Release Member

The mold release member in the present disclosure is a member configured to support the mold releasing support. In the present disclosure, the mold release member is peeled off from the transfer sheet with mold release member before the transfer sheet and the decorative object are integrated.

In the present disclosure, the elongation rate of the mold release member at 130° C. is lower than the elongation rate of the mold releasing support at 130° C. Specifically, the elongation rate of the mold release member at 130° C. is preferably 20% or less. By the elongation rate being in the range, the mold releasing support may be suppressed from being stretched due to the heat and pressure of the thermal head, during the formation of the thermal transfer image in the case of thermal transfer method. Also, in the case of electrophotography method, the mold releasing support may be suppressed from being stretched due to the heat and pressure from the drum during the formation of the toner image. Thereby, it is possible to suppress the print wrinkles and print unevenness due to the stretch of the mold releasing support. Meanwhile, the lower limit of the elongation rate of the mold release member at 130° C. is not particularly limited.

Here, the elongation rate of the mold release member at 130° C. may be measured by a test method compliant to JIS K7127:1999. Specifically, using a tensile tester, a test piece is pulled at a temperature of 130° C. and at a speed of 200 mm/minute, compliant to JIS K7127:1999, the elongation rate of the test piece when the test piece breaks. (fractures) is regarded as the elongation rate of the mold release member at 130° C. The elongation rate at 130° C. is calculated by the following formula (1). As the tensile tester, for example, a tensilon universal material testing instrument may be used.

Elongation rate (%)=100×(L−L₀)/L₀ (1)

(In the above formula (1), L₀ is the length of the test piece before the test and L is the length of the test piece at the time of the fracture.)

The mold release member is not particularly limited as long as it satisfies the elongation rate at 130° C. described above, and for example, a mold release film may be used. The mold release film may be selected and used as appropriate from generally used mold release films. Examples of the mold release film may include resin films including a mold release layer on the surface, and not treated resin films having mold release properties.

The resin film is not particularly limited as long as it satisfies the elongation rate at 130° C. described above, and for example, it is similar to the substrate 211 in the decorative sheet in the first embodiment described above. Also, the resin film may be a porous resin film such as a porous polyethylene terephthalate film. Also, the resin film may have a single-layer structure, and may have a stacked-layer structure.

The mold release agent included in the mold release layer is similar to the material of the mold release layer 212 in the decorative sheet in the first embodiment described above.

The mold release member may include an antistatic agent. Adhesion of foreign matter to the transfer sheet with a mold release member may be suppressed. As the antistatic agent, commonly used antistatic agents may be used.

The thickness of the mold release member is not particularly limited as long as it is a thickness that satisfies the elongation rate at 130° C. described above, and the thickness is appropriately adjusted according to the material quality of the mold release member. The thickness of the mold release member is, for example, 25 μm or more and 1000 μm or less, and may be 50 μm or more and 300 μm or less. When the thickness of the mold release member is too thin, the elongation rate at 130° C. described above may not be satisfied, depending on the material quality of the mold release member.

### 2. Mold Releasing Support

The mold releasing support in the present disclosure is a member configured to support the image layer. In the present disclosure, the mold releasing support is peeled off from the transfer sheet after the decorative object and the transfer sheet after the mold release member has been peeled off, are integrated.

In the present disclosure, the elongation rate of the mold releasing support at 130° C. is higher than the elongation rate of the mold release member at 130° C. Specifically, the elongation rate of the mold releasing support at 130° C. is preferably 200% or more. By the elongation rate being in the above range, the elongation of the transfer sheet after the mold release member has been peeled off may be improved, and the moldability of the transfer sheet may be improved. Meanwhile, the upper limit of the elongation rate of the mold releasing support at 130° C. is not particularly limited, and it is, for example, 500% or less.

Here, the method for measuring the elongation rate of the mold releasing support at 130° C. is similar to the method for measuring the elongation rate of the mold release member at 130° C. described above.

In the present disclosure, as described above, the mold releasing support is peeled off from the transfer sheet after the decorative object and the transfer sheet after the mold release member has been peeled off, are integrated. Therefore, the mold releasing support may be transparent, and may be opaque.

The mold releasing support is not particularly limited as long as it satisfies the elongation rate at 130° C. described above, and examples thereof may include thermoplastic resin films. Examples of the thermoplastic resin that constitutes the thermoplastic resin films may include acrylic based resins, vinyl chloride based resins, ABS resins (acrylonitrile-styrene-butadiene copolymer), styrene based resins, polycarbonate based resins, polyester based resins, polyolefin based resins, and urethane based resins. Examples of the polyester based resin may include polyethylene terephthalate (PET). Examples of the polyolefin based resins may include polyethylene, polypropylene, polymethylpentene, polybutene, ethylene-propylene copolymer, propylene-butene copolymer, and olefin based thermoplastic elastomers.

The mold releasing support may include various additives as necessary. Examples of the additives may include stabilizers, plasticizers, colorants, ultraviolet absorbers, light stabilizers, and extender pigments.

The mold releasing support may have a single-layer structure, and may have a stacked-layer structure.

The thickness of the mold releasing support is not particularly limited as long as it is a thickness that satisfies the elongation rate at 130° C. described above, and is, for example, 30 μm or more and 300 μm or less, and may be 50 μm or more and 125 μm or less. When the thickness of the mold releasing support is in the above range, the handling ability, when the decorative object is decorated, of the transfer sheet after the mold release member has been peeled off may be improved. Meanwhile, when the thickness of the mold releasing support is too thick, the elongation rate at 130° C. described above may not be satisfied depending on the material quality of the mold releasing support.

### 3. Transfer Layer

The transfer layer in the present disclosure includes, in sequence from a mold releasing support side, a protective layer, an image layer including a thermal transfer image or a toner image, and a pressure-sensitive adhesive layer.

### (1) Protective Layer

The protective layer in the present disclosure is a member configured to protect the image layer in the decorative article using the transfer sheet.

The protective layer may include curable resin, and may include non-curable resin. The curable resin is similar to the curable resin included in the curable resin composition used for the hard coating precursor layer when the protective layer is a hard coating precursor layer, as described below. Also, the non-curable resin is similar to the non-curable resin used for the protective layer in the decorative sheet in the first embodiment described above. Above all, the protective layer preferably includes the non-curable resin, and more preferably includes the acrylic resins.

The protective layer may be a hard coating precursor layer. The hard coating precursor layer is a precursor of the hard coating layer, and a hard coating layer is obtained by curing the hard coating precursor layer. The hard coating layer is a member configured to protect the image layer in the decorative article using the transfer sheet. Also, by the hard coating layer, scuff resistance may be improved.

The hard coating precursor layer preferably includes curable resin composition. Examples of the curable resin composition may include thermally curable resin composition, and ionizing radiation curable resin composition. Among them, the ionizing radiation curable resin composition is preferable.

Incidentally, the ionizing radiation refers to, among electromagnetic waves or charged particle beams, one having energy quantum capable of polymerizing or cross-linking molecules; ultraviolet rays (UV) or electron beams (EB) is usually used, and in addition to the above, electromagnetic waves such as X-rays and γ-rays; and charged particle beams such as x-rays and ion rays may be used.

The thermosetting resin composition is a composition including at least thermosetting resin and is a resin composition cured by heating. Examples of the thermosetting resin may include acrylic resin, urethane resin, phenolic resin, urea melamine resin, epoxy resin, unsaturated polyester resin, and silicone resin. If necessary, a curing agent is added to the thermosetting resin composition.

The ionizing radiation curable resin composition is a composition including ionizing radiation curable resin. The ionizing radiation curable resin includes an ionizing radiation curable functional group. Examples of the ionizing radiation curable functional group may include an ethylenically unsaturated bonding group, an epoxy group, and an oxetanyl group. Examples of the ethylenically unsaturated bonding group may include a (meth) acryloyl group, a vinyl group, and an allyl group. Examples of the ionizing radiation curable resin may include acryl(meth) acrylate, urethane(meth) acrylate, polyester(meth) acrylate, epoxy(meth) acrylate, and polyether(meth) acrylate. Among them, urethane(meth) acrylate is preferable. One kind of the ionizing radiation curable resin may be used alone, and two kinds or more may be used in combination.

Also, ionizing radiation curable composition may additionally include multi-functional isocyanates. The multi-functional isocyanate may be selected and used as appropriate from compounds including two or more generally used isocyanate groups.

The ionizing radiation curable composition may include a photopolymerization initiator. The photopolymerization initiator may be selected and used as appropriate from generally used photopolymerization initiators. One kind of the photopolymerization initiator may be used alone, and two kinds or more may be used in combination.

The content of the photopolymerization initiator is, for example, 0.5 parts by mass or more and 10 parts by mass or less, may be 1 part by mass or more and 8 parts by mass or less, and may be 3 parts by mass or more and 8 parts by mass or less, with respect to 100 parts by mass of the ionizing radiation curable resin.

The ionizing radiation curable composition may include various additives according to the desired properties. Examples of the additive may include ultraviolet absorbers, infrared absorbers, photostabilizers, polymerization inhibitors, crosslinkers, antistatic agents, antioxidants, leveling agents, thixotropy imparting agents, coupling agents, plasticizers, antifoaming agents, and fillers.

The thickness of the protective layer is, for example, 0.5 μm or more and 30 μm or less, may be 1 μm or more and 20 μm or less, and may be 3 μm or more and 10 μm or less. When the thickness of the protective layer is in the above range, when the protective layer is a hard coating precursor layer, scuff resistance may be imparted to the hard coating layer obtained by curing the hard coating precursor layer. Also, the transcription ability may be improved.

### (2) Image Layer

The image layer in the present disclosure includes a thermal transfer image or a toner image. In the case of the thermal transfer method, the image layer includes a thermal transfer image. In the case of the electrophotography method, the image layer includes a toner image.

### (a) Thermal Transfer Image

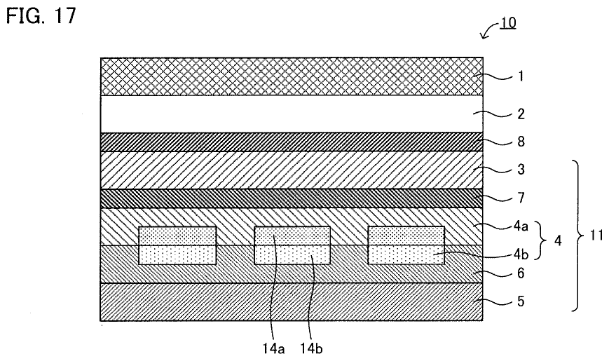

The thermal transfer image may be a thermal transfer image formed by a sublimation type thermal transfer method, and may be a thermal transfer image formed by a melting type thermal transfer method. Also, the image layer may include a first image layer including a thermal transfer image formed by the sublimation type thermal transfer method, and a second image layer including a thermal transfer image formed by the melting type thermal transfer method. In this case, the stacking order of the first image layer and second image layer is not particularly limited. In sequence from the protective layer side, the image layer may include the first image layer and the second image layer, and may include the second image layer and the first image layer. In FIG. 17 for example, the image layer 4 may include, in sequence from the protective layer 3 side, a first image layer 4a including a thermal transfer image 14a formed by the sublimation type thermal transfer method, and a second image layer 4b including a thermal transfer image 14b formed by the melting type thermal transfer method.

The sublimation type thermal transfer method is as described in the section of the decorative sheet in the first embodiment described above. The image layer including a thermal transfer image formed by the sublimation type thermal transfer method is a receptor layer including a thermal transfer image including a sublimation dye. The receptor layer is a layer capable of accepting the sublimation dye. The receptor layer includes a component capable of accepting the sublimation dye. The component capable of accepting the sublimation dye may be selected and used appropriately from the material of commonly used receptor layers used for the thermal transfer image receiving sheet. One kind of the component may be used alone, and two kinds or more may be used in combination.

The melting type thermal transfer method is as described in the section of the decorative sheet in the first embodiment described above. The image layer including a thermal transfer image formed by the melting type thermal transfer method is a melted ink layer.

### (b) Toner Image

The toner image is formed by the electrophotography method such as a laser method and a LED method. The image layer including the toner image includes toner. The toner includes, for example, resin components, pigments, charge control agents, and wax. The color of the colorant is not particularly limited. General toner may be used as the toner.

### (3) Pressure-Sensitive Adhesive Layer

The pressure-sensitive adhesive layer in the present disclosure is a layer in contact with the decorative object in the transfer sheet, and is a member configured to improve the close adhesiveness with the decorative object.

The pressure-sensitive adhesive layer is preferably transparent. In the decorative article using the transfer sheet with a mold release member in the present disclosure, when the decorative object is transparent, and when the observer observes the decorative object from the decorative object side, for example, the transparency of the pressure-sensitive adhesive layer makes the thermal transfer image or the toner image of the image layer visible.

Incidentally, the transparency of the pressure-sensitive adhesive layer means it is transparent to the extent that the thermal transfer image or the toner image of the image layer is visible when viewed from the pressure-sensitive adhesive layer side.

The pressure-sensitive adhesive used for the pressure-sensitive adhesive layer may be a pressure-sensitive type adhesive, and may be a curable type adhesive. The main component of the pressure-sensitive adhesive used for the pressure-sensitive adhesive layer is similar to the resin used for the pressure-sensitive adhesive layer when the second adhesive layer 215 in the decorative sheet in the first embodiment described above is a pressure-sensitive adhesive layer.

Also, the pressure-sensitive adhesive layer may include a curing agent, if necessary. The curing agent is appropriately selected according to the type of the resin. When the pressure-sensitive adhesive layer includes the curing agent, the pressure-sensitive adhesive layer may be cured after integrating the decorative object and the transfer sheet after the mold release member has been peeled off.

Also, the pressure-sensitive adhesive layer may include an adhesiveness imparting resin.

The thickness of the pressure-sensitive adhesive layer is appropriately selected according to the method for decorating a decorative object, and for example, it is 1 μm or more and 100 μm or less, may be 30 μm or more and 95 μm or less, and may be 50 μm or more and 85 μm or less. When the thickness of the pressure-sensitive adhesive layer is in the above range, the close adhesiveness with the decorative object may be improved. Also, the transcription ability may be improved.

### (4) Intermediate Layer

For example, as shown in FIG. 17, the transfer layer in the present disclosure preferably includes an intermediate layer 6 between the image layer 4 and the pressure-sensitive adhesive layer 5. By the intermediate layer, the migration of the component included in the thermal transfer image of the image layer, to the pressure-sensitive adhesive layer, may be suppressed. This may suppress the blurring of the thermal transfer image. When the image layer includes a thermal transfer image formed by the sublimation type thermal transfer method, the dye included in the thermal transfer image is easily migrated to the pressure-sensitive adhesive layer. Therefore, when the image layer includes a thermal transfer image formed by the sublimation type thermal transfer method, the intermediate layer is preferably placed between the image layer and the pressure-sensitive adhesive layer.

The material of the intermediate layer is appropriately selected according to, for example, the material of the image layer or the component of the thermal transfer image. Examples of the material of the intermediate layer may include acrylic resin, polyester, polyurethane, vinyl chloride-vinyl acetate copolymer, cellulose resin, polyvinylpyrrolidone, and polyvinyl alcohol. One kind of the material may be used alone, and two kinds or more may be used in combination.

Also, the intermediate layer preferably includes an ultraviolet absorber. The light resistance of the thermal transfer image or toner image in the image layer may be improved. Particularly, when the protective layer is cured by ultraviolet rays, or when the pressure-sensitive adhesive layer is cured by ultraviolet rays, the deterioration of the thermal transfer image or toner image due to ultraviolet rays may be suppressed. Commonly used ultraviolet absorbers may be used as the ultraviolet absorber.

The intermediate layer may have a single-layer structure, and may have a stacked-layer structure.

Also, the intermediate layer preferably has a high heat resistance. Thereby, the melting and softening of the intermediate layer, during the production of the decorative article by using the transfer sheets, may be suppressed. As a result, damage to the thermal transfer image or toner image may be reduced. Also, the migration of the component included in the thermal transfer image of the image layer, to the pressure-sensitive adhesive layer, may be suppressed.

Specifically, the glass transition temperature of the intermediate layer is preferably 100° C. or more, more preferably 130° C. or more, and further preferably 150° C. or more. The glass transition temperature of the intermediate layer may be determined by differential scanning calorimetry (DSC) compliant with JIS K2171.

The thickness of the intermediate layer is, for example, 0.01 μm or more and 5 μm or less. When the thickness of the intermediate layer is in the above range, the migration of the component included in the thermal transfer image of the image layer, to the pressure-sensitive adhesive layer, may be suppressed.

### (5) Anchor Layer

For example, as shown in FIG. 17, the transfer layer in the present disclosure may include an anchor layer 7 between the image layer 4 and the protective layer 3. By the anchor layer, the close adhesiveness between the image layer and the protective layer may be improved.

Examples of the material of the anchor layer may include acrylic based resin, vinyl chloride based resin, vinyl acetate based resin, polyester based resin, and urethane based resin.

Also, the anchor layer may include an additive such as an ultraviolet absorber and a light stabilizer.

Above all, the anchor layer preferably includes an ultraviolet absorber. The light resistance of the thermal transfer image or toner image in the image layer may be improved. Particularly, when the protective layer is cured by ultraviolet rays, or when the pressure-sensitive adhesive layer is cured by ultraviolet rays, the deterioration of the thermal transfer image or toner image due to ultraviolet rays may be suppressed. Commonly used ultraviolet absorbers may be used as the ultraviolet absorber.

Also, the anchor layer preferably has a high heat resistance. Thereby, the melting and softening of the anchor layer, during the production of the decorative article by using the transfer sheet, may be suppressed. As the result, damage to the thermal transfer image or toner image may be reduced. Also, the component included in the thermal transfer image of the anchor layer may be suppressed from being dispersed from the image layer.

Specifically, the glass transition temperature of the anchor layer is preferably 100° C. or more, more preferably 130° C. or more, and further preferably 150° C. or more. The method for measuring the glass transition temperature of the anchor layer is similar to the method for measuring the glass transition temperature of the intermediate layer described above.

The thickness of the anchor layer is not particularly limited, and it is, for example, 0.1 μm or more and 10 μm or less.

### 4. Mold Release Layer

For example, as shown in FIG. 17, the transfer sheet with a mold release member in the present disclosure may include a mold release layer 8 between the mold releasing support 2 and the protective layer 3. By the mold release layer, the peeling ability between the mold releasing support and the protective layer may be improved.

The mold release layer is constituted so that the close adhesiveness between the mold release layer and the mold releasing support is higher than that between the mold release layer and the protective layer. The material of the mold release layer is similar to the material of mold release layer 212 in the decorative sheet in the first embodiment described above.

The thickness of the mold release layer is, for example, 0.1 μm or more and 1 μm or less.

5. Method for Producing Transfer Sheet with Mold Release Member

The transfer sheet with a mold release member in the present disclosure may be produced by the method for producing a transfer sheet described below.

B. Decorative Sheet with Mold Release Member

The decorative sheet with a mold release member in the present disclosure comprises a mold release member, a substrate layer, an image layer including a thermal transfer image or a toner image, and a protective layer in this order; and an elongation rate of the mold release member at 130° C. is lower than an elongation rate of the substrate layer at 130° C.

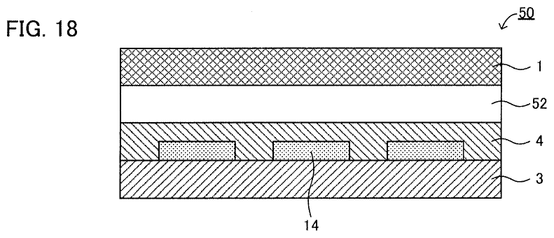

FIG. 18 is a schematic cross-sectional view illustrating an example of a decorative sheet with a mold release member in the present disclosure. As shown in FIG. 18, a decorative sheet with a mold release member 50 in the present disclosure comprises a mold release member 1, a substrate layer 52, an image layer 4 including a thermal transfer image 14, and a protective layer 3 in this order. In the decorative sheet with a mold release member 50, the elongation rate of the mold release member 1 at 130° C. is lower than the elongation rate of the substrate layer 52 at 130° C.

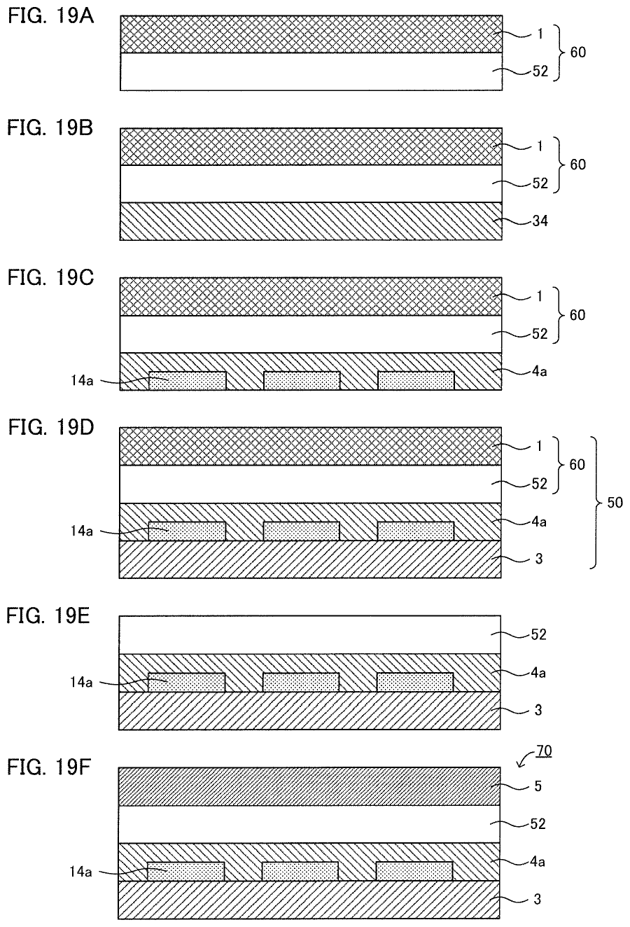

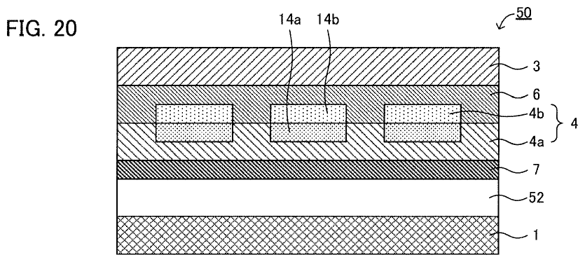

FIGS. 19A to 19F are process drawings illustrating an example of a method for producing a decorative sheet using the decorative sheet with a mold release member in the present disclosure, and the example is an example wherein the thermal transfer image is formed by a sublimation type thermal transfer method. Firstly, as shown in FIG. 19A, a stacked body for a decorative sheet 60 including a mold release member 1, and a substrate layer 52, is prepared. Then, as shown in FIG. 19B, a receptor layer 34 is formed on the substrate layer 52 side surface of the stacked body for a decorative sheet 60. Then, as shown in FIG. 19C, a thermal transfer image 14a is formed on the receptor layer 34 by a sublimation type thermal transfer method. Thereby, an image layer 4a including a thermal transfer image 14a is obtained. Then, as shown in FIG. 19D, a protective layer 3 is formed on the image layer 4a, on the surface opposite side to the stacked body for a decorative sheet 60. Thereby, a decorative sheet with a mold release member 50 is obtained. Then, as shown in FIGS. 19D to 19E, the mold release member 1 is peeled off from the stacked body for a decorative sheet 60. Then, as shown in FIG. 19F, a pressure-sensitive adhesive layer 5 is placed on the substrate layer 52, on the surface opposite side to the image layer 4a. Thereby, a decorative sheet 70 is obtained.

In the decorative sheet with a mold release member in the present disclosure, since a mold release member, a substrate layer, an image layer including a thermal transfer image or a toner image, and a protective layer are placed in this order, as shown in FIG. 19C for example, when the thermal transfer image is formed, the substrate layer is supported by the mold release member. Since the elongation rate of the mold release member at 130° C. is lower than the elongation rate of the substrate layer at 130° C., the substrate layer may be suppressed from being stretched, by the heat and pressure of the thermal head, during the formation of the thermal transfer image. Therefore, it is possible to suppress the print wrinkles and print unevenness due to the stretch of the substrate layer.

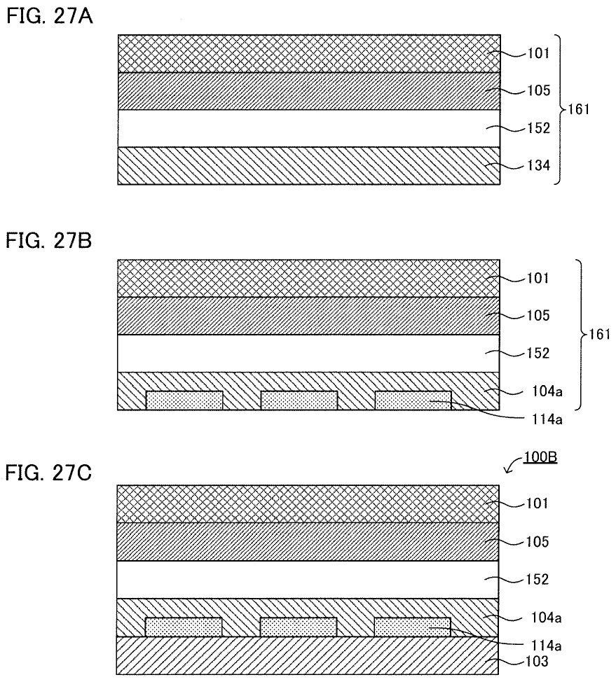

Here, FIGS. 27A to 27C are process drawings illustrating an example of a method for producing a decorative sheet not according to the present embodiment, and the example is an example wherein the thermal transfer image is formed by the sublimation type thermal transfer method. Firstly, as shown in FIG. 27A, a stacked body 161 including a separator 101, a pressure-sensitive adhesive layer 105, a substrate layer 152, and a receptor layer 134, is prepared. Then, as shown in FIG. 27B, a thermal transfer image 114a is formed on the receptor layer 134 by the sublimation type thermal transfer method. Thereby, an image layer 104a including a thermal transfer image 114a is obtained. Then, as shown in FIG. 27C, a protective layer 103 is formed on the image layer 104a, on the surface opposite side to the substrate layer 152. Thereby, a decorative sheet 100B is obtained.

In the method for producing a decorative sheet shown in FIGS. 27A to 27C, when the thermal transfer image is formed, the pressure-sensitive adhesive layer 105 exists in the stacked body 161. When the stacked body 161 includes a relatively soft layer such as the pressure-sensitive adhesive layer 105, the image may crack due to the heat and pressure of the thermal head during the formation of the image when the thermal transfer image is formed, and may cause an appearance defect.

In contrast to this, in the decorative sheet with a mold release member in the present disclosure, since a mold release member, a substrate layer, an image layer including a thermal transfer image or a toner image, and a protective layer are placed in this order, as shown in FIG. 19C for example, when the thermal transfer image is formed, the pressure-sensitive adhesive layer does not exist in the stacked body for a decorative sheet. Therefore, the thermal transfer image may be suppressed from being cracked, by the heat and pressure of the thermal head, during the formation of the thermal transfer image.

Incidentally, in the method for producing a decorative sheet shown in FIGS. 27A to 27C, the reason why the pressure-sensitive adhesive layer 105 is placed on the stacked body 161 prior to the formation of the thermal transfer image is to make the separator 101 to be the only one member peeled off prior to the integration of the decorative sheet and the decorative object. This reduces the number of processes and production costs. This separator 101 is a member configured to protect the pressure-sensitive adhesive layer 105.

Meanwhile, although not shown in the method for producing a decorative sheet in the present disclosure as shown in FIGS. 19A to 19F, in order to protect the pressure-sensitive adhesive layer 5, when the separator is placed on the pressure-sensitive adhesive layer 5, on the surface opposite side to the substrate layer 52, the two members peeled off before the decorative sheet and the decorative object are integrated are the mold release member 1 and the separator. In the present disclosure, although the number of members peeled off before the decorative sheet and the decorative object are integrated increases, the cracking of the thermal transfer image may be suppressed.

In the example above, the case wherein the thermal transfer image is formed by a thermal transfer method, was described, and similarly in a case wherein a toner image is formed by the electrophotography method, the toner image may be suppressed from cracking due to the heat and pressure of the drum during the formation of the toner image.

Also, the decorative sheet with the mold release member in the present disclosure is used for decoration by the adhesion method. As shown in FIGS. 19D to 19F for example, when a decorative object is subjected to a decoration, the mold release member is peeled off from the decorative sheet with a mold release member, and the pressure-sensitive adhesive layer is placed on the substrate layer, on the surface opposite side to the image layer.

In the decorative sheet with a mold release member in the present disclosure, since the substrate layer is supported by the mold release member when the thermal transfer image or the toner image is formed, the substrate layer may be suppressed from being stretched; whereas, since the mold release member is peeled off when the decorative object is decorated, the elongation of the decorative sheet after the mold release member has been peeled off may be improved so that the molding ability of the decorative sheet may be improved.

Therefore, according to the decorative sheet with a mold release member in the present disclosure, an appearance defect may be suppressed. Particularly, when the decorative sheet is used to decorate the decorative object by the TOM method, the decorative sheet with a mold release member in the present disclosure is useful.

Also, in the decorative sheet with a mold release member in the present disclosure, since the image layer includes a thermal transfer image or a toner image, on-demand printing is possible so that it is suitable for a small-lot, a wide variety, or a short delivery time production.

Each constitution of the decorative sheet with a mold release member in the present disclosure is hereinafter described.

### 1. Mold Release Member

The mold release member in the present disclosure is a member configured to support the substrate layer. In the present disclosure, the mold release member is peeled off from the decorative sheet with a mold release member before the pressure-sensitive adhesive layer is placed in the decorative sheet. The mold release member is similar to the mold release member in the transfer sheet with a mold release member described above.

### 2. Substrate Layer

The substrate layer in the present disclosure is a member configured to support the image layer.

The elongation rate of the substrate layer at 130° C. is similar to that of the mold releasing support in the transfer sheet with a mold release member described above.

The substrate layer is preferably transparent. In the decorative article using the decorative sheet with a mold release member in the present disclosure, by the substrate layer being transparent, when an observer observes the decorative article from the decorative sheet side, for example, the thermal transfer image or the toner image of the image layer is visible.

Incidentally, the transparency of the substrate layer means it is transparent to the extent that the thermal transfer image or the toner image of the image layer is visible when observed from the substrate layer side.

As the substrate layer, a resin film may be used. Above all, the substrate layer is preferably a resin film that satisfies the elongation rate at 130° C. described above. The resin film is similar to the resin film used for the mold releasing support in the transfer sheet with a mold release member described above.

The substrate layer may include various additives as necessary. Examples of the additives may include stabilizers, plasticizers, colorants, ultraviolet absorbers, light stabilizers, and extender pigments.

The substrate layer may have a single-layer structure, and may have a stacked-layer structure.

The thickness of the substrate layer is not particularly limited as long as it is a thickness that satisfies the elongation rate at 130° C. described above, and is, for example, 25 μm or more and 450 μm or less, may be 30 μm or more and 300 μm or less, and may be 50 μm or more and 200 μm or less. When the thickness of the substrate layer is in the above range, the handling ability of the decorative sheet, when the decorative object is decorated, may be improved. Also, the trimming of the excess portion of the decorative sheet, after integrating the decorative sheet and the decorative object, is easy. Meanwhile, when the thickness of the substrate layer is too thick, the elongation rate at 130° C. described above may not be satisfied depending on the material quality of the substrate layer.

### 3. Protective Layer

The protective layer in the present disclosure is a member configured to protect the image layer in the decorative article using the decorative sheet. The protective layer is similar to the protective layer in the transfer sheet with a mold release member described above.

Also, the protective layer may be a hard coating precursor layer. The hard coating precursor layer is a precursor of the hard coating layer, and a hard coating layer is obtained by curing the hard coating precursor layer. The hard coating layer is a member configured to protect the image layer in the decorative article using the decorative sheet. Also, by the hard coating layer, scuff resistance may be improved. The hard coating precursor layer is similar to the hard coating precursor layer in the transfer sheet with a mold release member described above.

### 4. Image Layer

The image layer in the present disclosure includes a thermal transfer image or a toner image. The image layer is similar to the image layer in the transfer sheet with a mold release member described above.

### 5. Intermediate Layer

For example, as shown in FIG. 19, the decorative sheet with a mold release member in the present disclosure preferably includes an intermediate layer 6 between the image layer 4 and the protective layer 3. By the intermediate layer, the migration of the component included in the thermal transfer image of the image layer, to the pressure-sensitive adhesive layer, may be suppressed. This may suppress the blurring of the thermal transfer image. Particularly, when the image layer includes a thermal transfer image formed by the sublimation type thermal transfer method, the intermediate layer is preferably placed between the image layer and the pressure-sensitive adhesive layer. The intermediate layer is similar to the intermediate layer in the transfer sheet with a mold release member described above.

### 6. Anchor Layer

For example, as shown in FIG. 19, the decorative sheet with a mold release member in the present disclosure may include an anchor layer 7 between the image layer 4 and the substrate layer 52. By the anchor layer, the close adhesiveness between the image layer and the substrate layer may be improved. The anchor layer is similar to the anchor layer in the transfer sheet with a mold release member described above.

7. Method for Producing Decorative Sheet with Mold Release Member

The decorative sheet with a mold release member in the present disclosure may be produced by the method for producing a decorative sheet described below.

### C. Transfer Sheet Precursor

The transfer sheet precursor in the present disclosure comprises a mold release member, a mold releasing support and a protective layer in this order, wherein an elongation rate of the mold release member at 130° C. is lower than an elongation rate of the mold releasing support at 130° C.

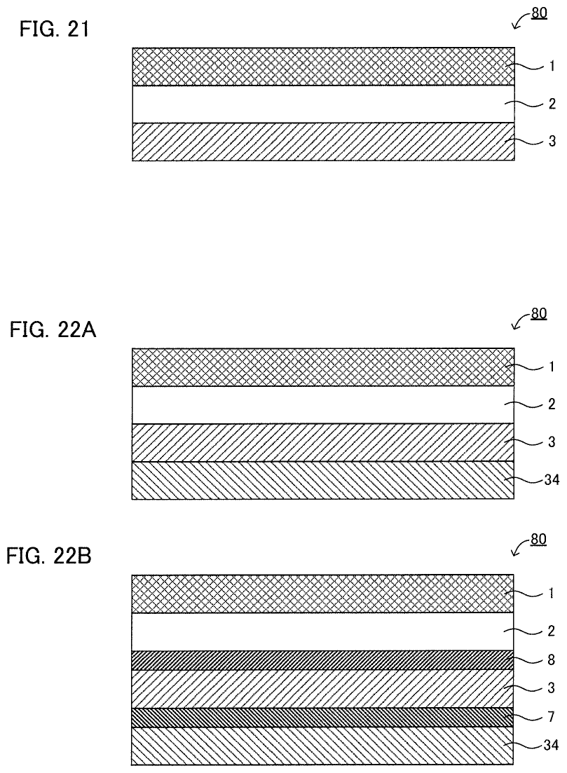

FIG. 21 is a schematic cross-sectional view illustrating an example of a transfer sheet precursor in the present disclosure. As shown in FIG. 21, a transfer sheet precursor 80 comprises a mold release member 1, a mold releasing support 2 and a protective layer 3 in this order. In the transfer sheet precursor 80, the elongation rate of the mold release member 1 at 130° C. is lower than the elongation rate of the mold releasing support 2 at 130° C.

When a transfer sheet is produced using the transfer sheet precursor in the present disclosure, since the mold releasing support is supported by the mold release member during the formation of the thermal transfer image, the elongation of the mold releasing support may be suppressed.

Also, when decorative article is produced using the transfer sheet precursor in the present disclosure, by peeling the mold release member previously in the decoration of the decorative object, the elongation of the transfer sheet after the mold release member has been peeled off may be improved so that the molding ability of the transfer sheet may be improved.

Therefore, according to the transfer sheet precursor in the present disclosure, an appearance defect may be suppressed.

In the present disclosure, the mold release member, mold releasing support, and protective layer are similar to the mold release member, mold releasing support, and protective layer in the transfer sheet with a mold release member described above.

For example, as shown in FIG. 22A, the transfer sheet precursor in the present disclosure may include the mold release member 1, mold releasing support 2, protective layer 3, and receptor layer 34 in this order. The receptor layer is a layer capable of accepting the sublimation dye, and is a layer prior to the formation of the thermal transfer image. The material and thickness of the receptor layer are similar to the receptor layer in the transfer sheet with a mold release member described above.

For example, as shown in FIG. 22B, the transfer sheet precursor in the present disclosure may include an anchor layer 7 between the receptor layer 34 and the protective layer 3. The anchor layer is similar to the anchor layer in the transfer sheet with a mold release member described above.

Also, for example, as shown in FIG. 22B, the transfer sheet precursor in the present disclosure may include a mold release layer 8 between the mold releasing support 2 and the protective layer 3. The mold release layer is similar to the mold release layer in the transfer sheet with a mold release member described above.

### D. Decorative Sheet Precursor

The decorative sheet precursor in the present disclosure comprises a mold release member and a substrate layer, wherein an elongation rate of the mold release member at 130° C. is lower than an elongation rate of the substrate layer at 130° C.

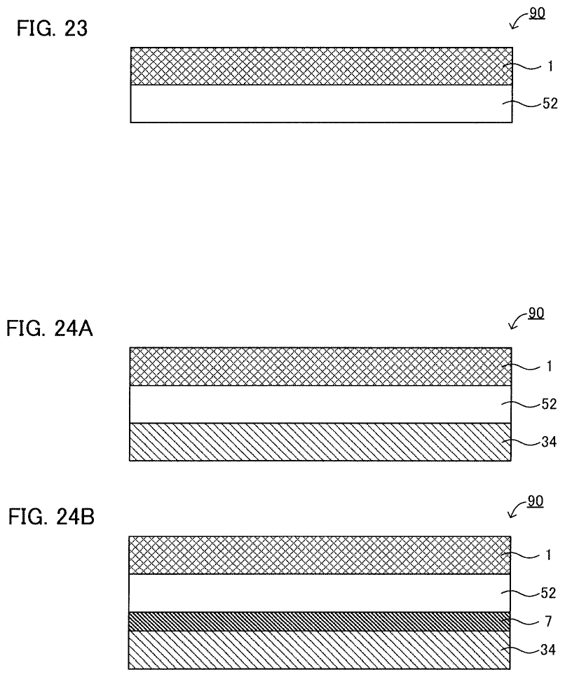

FIG. 23 is a schematic cross-sectional view illustrating an example of a decorative sheet precursor in the present disclosure. As shown in FIG. 23, a decorative sheet precursor 90 includes a mold release member 1, a substrate layer 52. In the decorative sheet precursor 90, the elongation rate of the mold release member 1 at 130° C. is lower than the elongation rate of the substrate layer 52 at 130° C.

When a decorative sheet is produced using the decorative sheet precursor in the present disclosure, since the substrate layer is supported by the mold release member during the formation of the thermal transfer image, the elongation of the substrate layer may be suppressed.

Also, when a decorative sheet is produced using the decorative sheet precursor in the present disclosure, the mold release member is peeled off, and a pressure-sensitive adhesive layer is placed on the substrate layer surface. Therefore, when decorative article is produced using the decorative sheet precursor in the present disclosure, since the mold release member is peeled off at the time of the decoration of the decorative object, the elongation of the decorative sheet may be improved so that the molding ability of the decorative sheet may be improved.

Therefore, according to the decorative sheet precursor in the present disclosure, an appearance defect may be suppressed.

In the present disclosure, the mold release member, and substrate layer are similar to the mold release member, and substrate layer in the decorative sheet with a mold release member described above.

For example, as shown in FIG. 24A, the decorative sheet precursor in the present disclosure may include the mold release member 1, substrate layer 52, and receptor layer 34 in this order. The receptor layer is a layer capable of accepting the sublimation dye, and is a layer prior to the formation of the thermal transfer image. The material and thickness of the receptor layer are similar to the receptor layer in the decorative sheet with a mold release member described above.

For example, as shown in FIG. 24B, the decorative sheet precursor in the present disclosure may include an anchor layer 7 between the receptor layer 34 and the substrate layer 52. The anchor layer is similar to the anchor layer in the decorative sheet with a mold release member described above.

### E. Method for Producing Transfer Sheet

The method for producing a transfer sheet in the present disclosure comprises: a preparing step of preparing a stacked body for a transfer sheet including a mold release member, a mold releasing support and a protective layer in this order, and an elongation rate of the mold release member at 130° C. is lower than an elongation rate of the mold releasing support at 130° C.; an image layer forming step of forming an image layer, including a thermal transfer image or a toner image, on a protective layer side surface of the stacked body for a transfer sheet; and a pressure-sensitive adhesive layer placing step of placing a pressure-sensitive adhesive layer on the image layer, on a surface opposite side to the stacked body for a transfer sheet.

FIGS. 14A to 14D are process drawings illustrating an example of a method for producing a transfer sheet in the present disclosure, and the example is an example wherein the thermal transfer image is formed by a sublimation type thermal transfer method. Firstly, as shown in FIG. 14A, a stacked body for a transfer sheet 20 including a mold release member 1, a mold releasing support 2, and a protective layer 3, in this order, is prepared. Then, as shown in FIG. 14B, a receptor layer 34 is formed on the protective layer 3 side surface of the stacked body for a transfer sheet 20. Then, as shown in FIG. 14C, a thermal transfer image 14a is formed on the receptor layer 34 by the sublimation type thermal transfer method. Thereby, an image layer 4a including a thermal transfer image 14a is obtained. Then, as shown in FIG. 14D, a pressure-sensitive adhesive layer 5 is placed on the image layer 4a, on the surface opposite side to the stacked body for a transfer sheet 20.

In the method for producing a transfer sheet in the present disclosure, since the mold releasing support is supported by the mold release member when the thermal transfer image or the toner image is formed, the mold releasing support may be suppressed from being stretched; whereas, by peeling the mold release member off previously at the time of the decoration of the decorative object, the elongation of the transfer sheet after the mold release member has been peeled off may be improved so that the molding ability of the transfer sheet may be improved. Therefore, an appearance defect may be suppressed.

Each step of the method for producing a transfer sheet in the present disclosure is hereinafter described.

### 1. Preparing Step

In the preparing step in the present disclosure, a stacked body for a transfer sheet including a mold release member, a mold releasing support and a protective layer in this order is prepared, and an elongation rate of the mold release member at 130° C. is lower than an elongation rate of the mold releasing support at 130° C.

The stacked body for a transfer sheet includes a mold release member, a mold releasing support and a protective layer in this order. Also, in the stacked body for a transfer sheet, an anchor layer may be included on the protective layer, on a surface opposite side to the mold releasing support. Also, the stacked body for a transfer sheet may include a mold release layer between the mold releasing support and the protective layer. The mold release member, mold releasing support, protective layer, anchor layer, and mold release layer are similar to the mold release member, mold releasing support, protective layer, and mold release layer in the transfer sheet with a mold release member described above.

The stacked body of the mold release member and mold releasing support may be produced, for example, by an extrusion-lamination method.

The method for forming a protective layer on the mold releasing support, on the surface opposite side to the mold release member is not particularly limited, and examples thereof may include a method wherein a mold releasing support is coated with a curable resin composition; and a method wherein, using a transfer sheet including a protective layer, the protective layer is transferred onto a mold releasing support. The transfer method may be a thermal transfer, and may be a non-thermal transfer.

### 2. Image Layer Forming Step

In the image layer forming step in the present disclosure, an image layer, including a thermal transfer image or a toner image, is formed on a protective layer side surface of the stacked body for a transfer sheet.

### (1) Method for Forming Image Layer Including Thermal Transfer Image

The method for forming a thermal transfer image is a thermal transfer method. Examples of the method for forming the thermal transfer image may include a sublimation type thermal transfer method and a melting type thermal transfer method.

In the case of the sublimation type thermal transfer method, using a transfer sheet precursor, wherein a receptor layer is formed on the protective layer side surface of the stacked body for a transfer sheet, and a sublimation type thermal transfer sheet including a color material layer including sublimation dye, a thermal transfer image is formed by applying a thermal energy according to the image information to the sublimation type thermal transfer sheet, and transferring the sublimation dye, included in the color material layer, to the receptor layer of the transfer sheet precursor.

The receptor layer is similar to the receptor layer in the transfer sheet precursor described above.

The method for forming a receptor layer on the protective layer side surface of the stacked body for a transfer sheet is not particularly limited, and examples thereof may include a method wherein a coating solution including material for a receptor layer is used, and a protective layer is coated with the coating solution; and a method wherein a transfer sheet including a receptor layer is used, and the receptor layer is transferred onto a protective layer. The transfer method may be a thermal transfer, and may be a non-thermal transfer.

As the sublimation type thermal transfer sheet, commonly used sublimation type thermal transfer sheets may be used.

The sublimation type thermal transfer sheet includes a supporting layer, and a color material layer, placed on one surface of the supporting layer, including a sublimation dye.

In the sublimation type thermal transfer sheet, one kind of the color material layer may be placed on one surface of the supporting layer, and a plurality types of color material layers in different colors may be placed in a plane.

In the case of the melting type thermal transfer method, using a stacked body for a transfer sheet including a mold release member, a mold releasing support, and a protective layer in this order, and a melting type thermal transfer sheet including a melting ink layer including melting ink, a thermal transfer image is formed by applying thermal energy according to the image information to the melting type thermal transfer sheet, and transferring the melt or softened melting ink layer, onto the protective layer side surface of the stacked body for a transfer sheet, as a whole layer, by an application of thermal energy.

As the melting type thermal transfer sheet, commonly used melting type thermal transfer sheets may be used.

### (2) Method for Forming Image Layer Including Toner Image

The method for forming a toner image is an electrophotography method. Examples of the electrophotography method may include a laser method and a LED method.

### 3. Pressure-Sensitive Adhesive Layer Placing Step

In the pressure-sensitive adhesive layer placing step in the present disclosure, a pressure-sensitive adhesive layer is placed on the image layer, on a surface opposite side to the stacked body for a transfer sheet.

The pressure-sensitive adhesive layer is similar to the pressure-sensitive adhesive layer in the transfer sheet with a mold release member described above.

The method for placing a pressure-sensitive adhesive layer on the image layer, on the surface opposite side to the stacked body for a transfer sheet is not particularly limited, and examples thereof may include a method wherein a pressure-sensitive adhesive composition is applied; a method wherein a pressure-sensitive adhesive film is used, and the pressure-sensitive adhesive film is laminated; and a method wherein a transfer sheet including a pressure-sensitive adhesive layer is used, and the pressure-sensitive adhesive layer is transferred. The transfer method may be a thermal transfer, and may be a non-thermal transfer. Above all, the method wherein a pressure-sensitive adhesive film is laminated is preferable, since the influence on the image layer, when the pressure-sensitive adhesive layer is formed, may be suppressed.

### 4. Intermediate Layer Placing Step

The method for producing a transfer sheet in the present disclosure may comprise, between the image layer forming step and the pressure-sensitive adhesive layer placing step, an intermediate layer placing step of placing an intermediate layer on the image layer, on a surface opposite side to the stacked body for a transfer sheet.

The intermediate layer is similar to the intermediate layer in the transfer sheet with a mold release member described above.

The method for placing an intermediate layer on the image layer, on the surface opposite side to the stacked body for a transfer sheet is not particularly limited, and examples thereof may include a method wherein a coating solution including material for an intermediate layer is applied; and a method wherein a transfer sheet including an intermediate layer is used, and the intermediate layer is transferred. The transfer method may be a thermal transfer, and may be a non-thermal transfer.

### F. Method for Producing Decorative Sheet

The method for producing a decorative sheet in the present disclosure comprises: a preparing step of preparing a stacked body for a decorative sheet including a mold release member and a substrate layer, and an elongation rate of the mold release member at 130° C. is lower than an elongation rate of the substrate layer at 130° C.; an image layer forming step of forming an image layer, including a thermal transfer image or a toner image, on a substrate layer side surface of the stacked body for a decorative sheet; a protective layer placing step of placing a protective layer on the image layer, on a surface opposite side to the stacked body for a decorative sheet; after the protective layer placing step, a peeling step of peeling the mold release member off from the stacked body for a decorative sheet; and after the peeling step, a pressure-sensitive adhesive layer placing step of placing a pressure-sensitive adhesive layer on the substrate layer, on a surface opposite side to the image layer.

FIGS. 19A to 19F are process drawings illustrating an example of a method for producing a decorative sheet in the present disclosure, and the example is an example wherein the thermal transfer image is formed by a sublimation type thermal transfer method. Firstly, as shown in FIG. 19A, a stacked body for a decorative sheet 60 comprising a mold release member 1, and a substrate layer 52, is prepared. Then, as shown in FIG. 19B, a receptor layer 34 is formed on the substrate layer 52 side surface of the stacked body for a decorative sheet 60. Then, as shown in FIG. 19C, a thermal transfer image 14a is formed on the receptor layer 34 by sublimation type thermal transfer method. Thereby, an image layer 4a including a thermal transfer image 14a is obtained. Then, as shown in FIG. 19D, a protective layer 3 is formed on the image layer 4a, on the surface opposite side to the stacked body for a decorative sheet 60. Then, as shown in FIGS. 19D to 19E, the mold release member 1 is peeled off from the stacked body for a decorative sheet 60. Then, as shown in FIG. 19F, a pressure-sensitive adhesive layer 5 is placed on the substrate layer 52, on the surface opposite side to the image layer 4a. Thereby, a decorative sheet 70 is obtained.

In the method for producing a decorative sheet in the present disclosure, since the substrate layer is supported by the mold release member when the thermal transfer image or the toner image is formed, the substrate layer may be suppressed from being stretched; whereas, by peeling the mold release member off previously at the time of the decoration of the decorative object, the elongation of the decorative sheet after the mold release member has been peeled off may be improved so that the molding ability of the decorative sheet may be improved. Therefore, an appearance defect may be suppressed.

Each step of the method for producing a decorative sheet in the present disclosure is hereinafter described.

### 1. Preparing Step

In the preparing step in the present disclosure, a stacked body for a decorative sheet including a mold release member and a substrate layer, and an elongation rate of the mold release member at 130° C. is lower than an elongation rate of the substrate layer at 130° C.

The stacked body for a decorative sheet includes a mold release member, a substrate layer. Also, in the stacked body for a decorative sheet, an anchor layer may be included on the substrate layer, on a surface opposite side to the mold release member. The mold release member, substrate layer, and anchor layer are similar to the mold release member, substrate layer, and anchor layer in the decorative sheet with a mold release member described above.

The stacked body of the mold release member and substrate layer may be produced, for example, by an extrusion-lamination method.

### 2. Image Layer Forming Step

In the image layer forming step in the present disclosure, an image layer, including a thermal transfer image or a toner image, is formed on a substrate layer side surface of the stacked body for a decorative sheet.

The method for forming the image layer is similar to the method for forming an image layer in the method for producing a transfer sheet described above.

### 3. Protective Layer Placing Step

In the protective layer placing step in the present disclosure, a protective layer is placed on the image layer, on a surface opposite side to the stacked body for a decorative sheet.

The method for forming a protective layer is not particularly limited, and examples thereof may include a method wherein a curable resin composition is applied; and a method wherein, using a transfer sheet including a protective layer, the protective layer is transferred. The transfer method may be a thermal transfer, and may be a non-thermal transfer.

### 4. Peeling Step

In the peeling step in the present disclosure, after the protective layer placing step, the mold release member is peeled off from the stacked body for a decorative sheet. Since the mold release member has a mold releasing property, it may be peeled off from the stacked body for a decorative sheet.

### 5. Pressure-Sensitive Adhesive Layer Placing Step

In the pressure-sensitive adhesive layer placing step in the present disclosure, after the peeling step, a pressure-sensitive adhesive layer is placed on the substrate layer, on a surface opposite side to the image layer.

The pressure-sensitive adhesive layer is similar to the pressure-sensitive adhesive layer in the decorative sheet with a mold release member described above.

The method for placing a pressure-sensitive adhesive layer on the substrate layer, on the surface opposite side to the image layer is not particularly limited, and examples thereof may include a method wherein a pressure-sensitive adhesive composition is applied; a method wherein a pressure-sensitive adhesive film is used, and the pressure-sensitive adhesive film is laminated; and a method wherein a transfer sheet including a pressure-sensitive adhesive layer is used, and the pressure-sensitive adhesive layer is transferred. The transfer method may be a thermal transfer, and may be a non-thermal transfer.

### 6. Intermediate Layer Placing Step

The method for producing a decorative sheet in the present disclosure may comprise, between the image layer forming step and the protective layer placing step, an intermediate layer placing step of placing an intermediate layer on the image layer, on a surface opposite side to the stacked body for a decorative sheet.

The intermediate layer is similar to the intermediate layer in the decorative sheet with a mold release member described above.

The method for placing an intermediate layer on the image layer, on the surface opposite side to the stacked body for a decorative sheet is not particularly limited, and examples thereof may include a method wherein a coating solution including material for an intermediate layer is applied; and a method wherein a transfer sheet including an intermediate layer is used, and the intermediate layer is transferred. In the case of the transfer method, a transfer sheet including an intermediate layer and a protective layer may be used, and the intermediate layer and the protective layer may be transferred. In this case, the protective layer placing step and the intermediate layer placing step may be carried out simultaneously. Also, the transfer method may be a thermal transfer, and may be a non-thermal transfer.

### G. Method for Producing Decorative Article

The method for producing a decorative article in the present disclosure includes two embodiments. Each embodiment is hereinafter described.

### I. Method for Producing Decorative Article of First Embodiment

The method for producing a decorative article in the present embodiment comprises: a transfer sheet with a mold release member producing step of producing a transfer sheet with a mold release member including a mold release member, a mold releasing support and a transfer layer in this order, and the transfer layer includes, in sequence form a mold releasing support side, a protective layer, an image layer including a thermal transfer image or a toner image, and a pressure-sensitive adhesive layer, by the method for producing a transfer sheet described above; a peeling step of obtaining a transfer sheet by peeling the mold release member off from the transfer sheet with a mold release member; an integrating step of integrating the transfer sheet and a decorative object by placing so that a surface of the pressure-sensitive adhesive layer of the transfer sheet and the decorative object are facing each other; and after the integrating step, a transferring step of peeling the mold releasing support off from the transfer sheet.

FIGS. 15A to 15C and FIGS. 16A and 16B are process drawings illustrating an example of a method for producing a decorative article in the present embodiment. Firstly, as shown in FIG. 15A, a transfer sheet with a mold release member 10 is produced. The transfer sheet with a mold release member 10 is similar to the transfer sheet with a mold release member 10 shown in FIG. 13. Then, as shown in FIGS. 15A and 15B, a transfer sheet 30 after the mold release member has been peeled off, is obtained by peeling the mold release member 1 off from the transfer sheet with a mold release member 10. Then, as shown in FIG. 15C, the transfer sheet 30 and the decorative object 41 are integrated. Then, as shown in FIGS. 15C to 16A, mold releasing support 2 is peeled off from the transfer sheet 30, and the transfer layer 11 is transferred to the decorative object 41. After that, when the protective layer includes curable resin composition, as shown in FIGS. 16A and 16B, the protective layer 3 is cured to form a cured protective layer 43. In doing so, when the pressure-sensitive adhesive layer 5 is a curable pressure-sensitive adhesive layer, the pressure-sensitive adhesive layer 5 may be cured. Thereby, a decorative article 40 is obtained.

According to the method for producing a decorative article in the present embodiment, since a decorative article may be produced by using the transfer sheet with a mold release member described above, an appearance defect may be suppressed.

Each step of the method for producing a decorative article in the present embodiment is hereinafter described.

1. Transfer Sheet with Mold Release Member Producing Step

In the transfer sheet with a mold release member producing step in the present embodiment, a transfer sheet with a mold release member including a mold release member, a mold releasing support and a transfer layer in this order is produced, and the transfer layer includes, in sequence form a mold releasing support side, a protective layer, an image layer including a thermal transfer image or a toner image, and a pressure-sensitive adhesive layer, by the method for producing a transfer sheet described above. Each layer constituting the transfer sheet with a mold release member and method for forming thereof are similar to the contents described for the transfer sheet with a mold release member and the method for producing a transfer sheet described above.

### 2. Peeling Step

In the peeling step in the present embodiment, a transfer sheet is obtained by peeling the mold release member off from the transfer sheet with a mold release member. Since the mold release member has a mold releasing property, it may be peeled off from the stacked body for a transfer sheet.

### 3. Integrating Step

In the integrating step in the present embodiment, the transfer sheet and a decorative object are integrated by placing so that a surface of the pressure-sensitive adhesive layer of the transfer sheet and the decorative object are facing each other.

The method for integrating the transfer sheet and the decorative object is not particularly limited as long as it is a method capable of transferring the transfer sheet. Above all, an overlay molding such as TOM molding is preferable. The overlay molding is advantageous such that it may be used regardless of the material of the decorative object. The overlay molding is also referred to as a vacuum/pressure molding.

The decorative object in the present embodiment is not particularly limited. Specifically, the shape, size and material, for example, of the decorative object is not particularly limited.

The decorative object preferably has a three-dimensional shape.

Examples of the decorative object may include fiber members, woody members, resin members, metal members, glass members, and ceramic members. Examples of the fiber member may include plain paper, high-quality paper, and tracing paper. Examples of the resin constituting the resin member may include polycarbonate, acrylic resin, ABS resin (acrylonitrile-styrene-butadiene copolymer) and polyvinyl chloride. Examples of the metal constituting the metal member may include aluminum.

The decorative object may have a single-layer structure, and may have a stacked-layer structure.

The decorative object may be transparent, and may be opaque. When the decorative object is transparent, the thermal transfer image of the image layer is visible when the decorative article is observed from the decorative object side. Also, a part of the decorative object may be transparent.

### 4. Transferring Step

In the transferring step in the present embodiment, after the integrating step, the mold releasing support is peeled off from the transfer sheet. Thereby, the transfer layer is transferred onto the decorative object. When a mold release layer is placed between the mold releasing support and the protective layer, the mold releasing support and mold release layer are peeled off from the transfer sheet.

### 5. Curing Step

When the protective layer includes curable resin composition, the method for producing a decorative article in the present embodiment includes a curing step of curing the protective layer, after the transferring step. By curing the protective layer after the transferring step, the cracking of the protective layer during the integrating step may be suppressed.

The method for curing a protective layer is appropriately selected according to the curable resin composition included in the protective layer, and examples thereof may include an irradiation of ionizing radiation, and heating.

When the pressure-sensitive adhesive layer is a curing pressure-sensitive adhesive layer, the pressure-sensitive adhesive layer may be cured together with the protective layer in the curing step. The method for curing a pressure-sensitive adhesive layer is appropriately selected according to the material included in the pressure-sensitive adhesive layer, and examples thereof may include an irradiation of ionizing radiation, an irradiation of visible light, and heating.

### II. Method for Producing Decorative Article of Second Embodiment

The method for producing a decorative article in the present embodiment comprise: a decorative sheet producing step of producing a decorative sheet including a pressure-sensitive adhesive layer, a substrate layer, an image layer including a thermal transfer image or a toner image, and a protective layer in this order, by the method for producing a decorative sheet described above; and an integrating step of integrating the decorative sheet and a decorative object by placing so that a surface of the pressure-sensitive adhesive layer of the decorative sheet and the decorative object are facing each other.

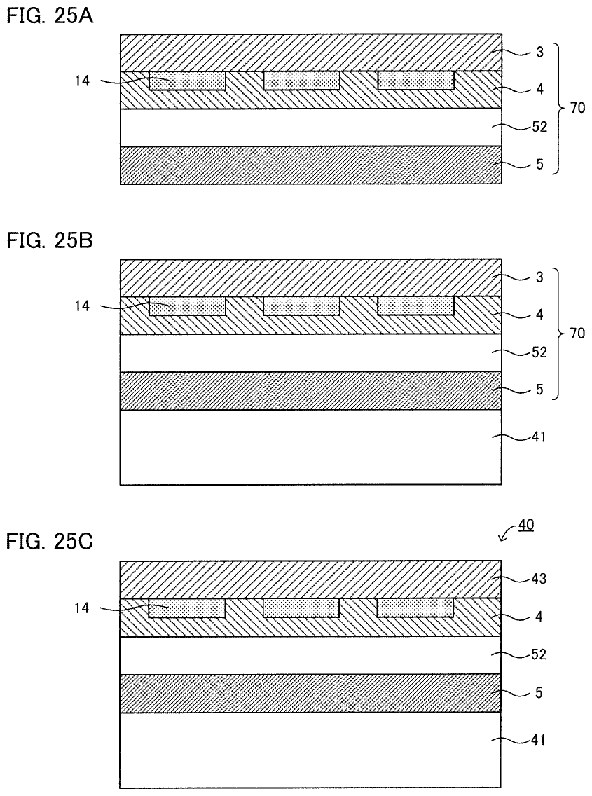

FIGS. 25A to and 25B are process drawings illustrating an example of a method for producing a decorative article in the present embodiment. Firstly, as shown in FIG. 25A, a decorative sheet 70 is produced. The method for producing the decorative sheet 70 is similar to the method for producing the decorative sheet 70 shown in FIGS. 19A to 19F. Then, as shown in FIG. 25B, the decorative sheet 70 and the decorative object 41 are integrated. After that, when the protective layer includes curable resin composition, as shown in FIGS. 25B and 25C, the protective layer 3 is cured to form a cured protective layer 43. In doing so, when the pressure-sensitive adhesive layer 5 is a curing pressure-sensitive adhesive layer, the pressure-sensitive adhesive layer 5 may be cured. Thereby, a decorative article 40 is obtained.

According to the method for producing a decorative article in the present embodiment, since a decorative article may be produced by using the decorative sheet with a mold release member described above, an appearance defect may be suppressed.

Each step of the method for producing a decorative article in the present embodiment is hereinafter described.

### 1. Decorative Sheet Producing Step

In the decorative sheet producing step in the present embodiment, a decorative sheet including a pressure-sensitive adhesive layer, a substrate layer, an image layer including a thermal transfer image or a toner image, and a protective layer in this order is produced, by the method for producing a decorative sheet described above. Each layer constituting the decorative sheet and method for forming thereof are similar to the contents described for the decorative sheet with a mold release member and the method for producing a decorative sheet described above.

### 2. Integrating Step

In the integrating step in the present embodiment, the decorative sheet and a decorative object are integrated by placing so that a surface of the pressure-sensitive adhesive layer of the decorative sheet and the decorative object are facing each other.

The method for integrating the decorative sheet and the decorative object is not particularly limited as long as it is a method capable of adhering the decorative sheet. Above all, an overlay method such as TOM molding is preferable. The overlay molding is advantageous such that it may be used regardless of the material of the decorative object.

The decorative object is similar to the method for producing a decorative article in the first embodiment.

### 3. Curing Step

When the protective layer includes curable resin composition, the method for producing a decorative article in the present embodiment includes a curing step of curing the protective layer, after the integrating step. By curing the protective layer after the integrating step, the cracking of the protective layer during the integrating step may be suppressed.

When the pressure-sensitive adhesive layer is a curing pressure-sensitive adhesive layer, the pressure-sensitive adhesive layer may be cured together with the protective layer in the curing step.

The method for curing a protective layer and the method for curing a pressure-sensitive adhesive layer are similar to the method for producing a decorative article in the first embodiment.

### 4. Trimming Step

The method for producing a decorative article in the present embodiment include a trimming step of trimming the excess part of the decorative sheet, after the integrating step described above. The trimming step is carried out before the curing step described above.

The method for trimming is not particularly limited, and examples thereof may include a method wherein a cutter or a laser is used.

Incidentally, the present disclosure is not limited to the embodiments. The embodiments are exemplification, and any other variations are intended to be included in the technical scope of the present disclosure if they have substantially the same constitution as the technical idea described in the claim of the present disclosure and offer similar operation and effect thereto.

### REFERENCE SIGNS LIST

1 . . . mold release member
2 . . . mold releasing support
3 . . . protective layer
4 . . . image layer
5 . . . pressure-sensitive adhesive layer
8 . . . mold release layer
10 . . . transfer sheet with a mold release member
11 . . . transfer layer
14 . . . thermal transfer image
20 . . . stacked body for a transfer sheet
30 . . . transfer sheet
34 . . . receptor layer
40 . . . decorative article
43 . . . cured protective layer
50 . . . decorative sheet with a mold release member
52 . . . substrate layer
60 . . . decorative sheet precursor
70 . . . decorative sheet
80 . . . transfer sheet precursor
90 . . . decorative sheet precursor
202 . . . molded article
210, 220, 230, 240 . . . decorative sheet
211, 221 . . . substrate
212, 243 . . . mold release layer
213, 228, 235, 244 . . . protective layer
214, 224, 234, 245 . . . image layer
232, 246 . . . adhesive layer
216, 226, 233, 242 . . . elongation substrate
222 . . . first mold release layer
217, 223 . . . first adhesive layer
215, 225 . . . second adhesive layer
227 . . . second mold release layer
231, 241 . . . peeling sheet

1. A method for producing a decorative molded article comprising:
a step of forming an image layer, by digital printing, on another surface of an elongation substrate provided with an adhesive layer and a peeling sheet on one surface;
a step of forming a protective layer on the image layer to produce a decorative sheet wherein the peeling sheet, the adhesive layer, the elongation substrate, the image layer and the protective layer are stacked; and
a step of removing the peeling sheet of the decorative sheet, and adhering the adhesive layer and a molded article to integrate the decorative sheet and the molded article.

2. A method for producing a decorative molded article comprising:
a step of preparing an elongation substrate wherein a peeling sheet is provided on one surface and a mold release layer is provided on another surface;
a step of forming a protective layer on the mold release layer;
a step of forming an image layer, by digital printing, on the protective layer;
a step of forming an adhesive layer on the image layer to produce a decorative sheet wherein the peeling sheet, the elongation substrate, the mold release layer, the protective layer, the image layer, and the adhesive layer are stacked;
a step of removing the peeling sheet of the decorative sheet, and adhering the adhesive layer and a molded article to integrate the decorative sheet and the molded article; and
a step of removing the elongation substrate and the mold release layer after integrating the decorative sheet and the molded article.

3. A method for producing a decorative molded article comprising:
a step of forming a protective layer on a substrate via a mold release layer;
a step of forming an image layer, by digital printing, on the protective layer;
a step of adhering the image layer of a stacked body wherein the substrate, the mold release layer, the protective layer and the image layer are stacked, on an elongation substrate via an adhesive layer;
a step of removing the substrate and the mold release layer to produce a decorative sheet wherein the elongation substrate, the adhesive layer, the image layer and the protective layer are stacked; and
a step of adhering the decorative sheet and a molded article to integrate the decorative sheet and the molded article.

4. A method for producing a decorative molded article comprising:
a step of stacking a first mold release layer and a first adhesive layer, in sequence, on a substrate;
a step of forming an image layer, by digital printing, on the first adhesive layer;
a step of preparing an elongation substrate wherein a second mold release layer and a protective layer are stacked on one surface in sequence, and adhering the image layer of a stacked body wherein the substrate, the first mold release layer, the first adhesive layer and the image layer are stacked, on the protective layer via a second adhesive layer;
a step of removing the substrate and the first mold release layer to produce a decorative sheet wherein the elongation substrate, the second mold release layer, the protective layer, the second adhesive layer, the image layer and the first adhesive layer are stacked; and
a step of adhering the first adhesive layer of the decorative sheet and a molded article, and removing the elongation substrate and the second mold release layer to integrate the decorative sheet and the molded article.

5. The method for producing a decorative molded article according to claim 1, wherein the decorative sheet and the molded article are integrated by an out-mold decoration.

6. The method for producing a decorative molded article according to claim 5, wherein the protective layer of the decorative sheet includes an uncured layer; and
the uncured layer is cured after the out-mold decoration.

7. The method for producing a decorative molded article according to claim 1, wherein the image layer is formed by a thermal transfer.

8. A decorative sheet comprising:
an elongation substrate;
an adhesive layer and a peeling sheet stacked in sequence on one surface of the elongation substrate;
an image layer including a digital print image provided on another surface of the elongation substrate; and
a protective layer provided on the image layer,
wherein the elongation substrate elongates 50% or more, when a tensile load of 0.05 N is applied at 90° C.

9. A decorative sheet comprising:
an elongation substrate;
a peeling sheet provided on one surface of the elongation substrate;
a mold release layer provided on another surface of the elongation substrate;
a protective layer provided on the mold release layer;
an image layer including a digital print image provided on the protective layer; and
an adhesive layer provided on the image layer,
wherein the elongation substrate elongates 50% or more, when a tensile load of 0.05 N is applied at 90° C.

10. A decorative sheet comprising:
an elongation substrate;
an adhesive layer provided on the elongation substrate;
an image layer including a digital print image provided on the adhesive layer; and
a protective layer provided on the image layer,
wherein the elongation substrate elongates 50% or more, when a tensile load of 0.05 N is applied at 90° C.

11. A decorative sheet comprising:
an elongation substrate;
a mold release layer provided on one surface of the elongation substrate;
a protective layer provided on the mold release layer;
a first adhesive layer provided on the protective layer;
an image layer, including a digital print image, provided on the first adhesive layer; and
a second adhesive layer provided on the image layer,
wherein the elongation substrate elongates 50% or more, when a tensile load of 0.05 N is applied at 90° C.

12. The decorative sheet according to claim 8, wherein the digital print image is a thermal transfer image.

13. A transfer sheet with a mold release member comprising a mold release member, a mold releasing support and a transfer layer in this order,
wherein the transfer layer includes, in sequence from a mold releasing support side, a protective layer, an image layer including a thermal transfer image or a toner image, and a pressure-sensitive adhesive layer; and
an elongation rate of the mold release member at 130° C. is lower than an elongation rate of the mold releasing support at 130° C.

14. The transfer sheet with a mold release member according to claim 13, wherein the transfer layer includes an intermediate layer between the image layer and the pressure-sensitive adhesive layer.

15. The transfer sheet with a mold release member according to claim 13, wherein the image layer includes a thermal transfer image.

16. A decorative sheet with a mold release member comprising a mold release member, a substrate layer, an image layer including a thermal transfer image or a toner image, and a protective layer in this order,
wherein an elongation rate of the mold release member at 130° C. is lower than an elongation rate of the substrate layer at 130° C.

17. The decorative sheet with a mold release member according to claim 16, wherein the image layer includes a thermal transfer image.

18. A transfer sheet precursor comprising a mold release member, a mold releasing support and a protective layer in this order,
wherein an elongation rate of the mold release member at 130° C. is lower than an elongation rate of the mold releasing support at 130° C.

19. The transfer sheet precursor according to claim 18, wherein a receptor layer is included on the protective layer, on a surface opposite side to the mold releasing support.

20. A decorative sheet precursor comprising a mold release member and a substrate layer, wherein an elongation rate of the mold release member at 130° C. is lower than an elongation rate of the substrate layer at 130° C.

21. The decorative sheet precursor according to claim 20, wherein a receptor layer is included on the substrate layer, on a surface opposite side the mold release member.

22. A method for producing a transfer sheet comprising:
a preparing step of preparing a stacked body for a transfer sheet including a mold release member, a mold releasing support and a protective layer in this order, and an elongation rate of the mold release member at 130° C. is lower than an elongation rate of the mold releasing support at 130° C.;
an image layer forming step of forming an image layer, including a thermal transfer image or a toner image, on a protective layer side surface of the stacked body for a transfer sheet; and
a pressure-sensitive adhesive layer placing step of placing a pressure-sensitive adhesive layer on the image layer, on a surface opposite side to the stacked body for a transfer sheet.

23. The method for producing a transfer sheet according to claim 22 comprising, between the image layer forming step and the pressure-sensitive adhesive layer placing step, an intermediate layer placing step of placing an intermediate layer on the image layer, on a surface opposite side to the stacked body for a transfer sheet.

24. The method for producing a transfer sheet according to claim 22, wherein, in the image layer forming step, the thermal transfer image is formed by a sublimation type thermal transfer method.

25. The method for producing a transfer sheet according to claim 22, wherein, in the image layer forming step, the thermal transfer image is formed by a melting type thermal transfer method.

26. A method for producing a decorative sheet comprising:
a preparing step of preparing a stacked body for a decorative sheet including a mold release member and a substrate layer, and an elongation rate of the mold release member at 130° C. is lower than an elongation rate of the substrate layer at 130° C.;
an image layer forming step of forming an image layer, including a thermal transfer image or a toner image, on a substrate layer side surface of the stacked body for a decorative sheet;
a protective layer placing step of placing a protective layer on the image layer, on a surface opposite side to the stacked body for a decorative sheet;
after the protective layer placing step, a peeling step of peeling the mold release member off from the stacked body for a decorative sheet; and
after the peeling step, a pressure-sensitive adhesive layer placing step of placing a pressure-sensitive adhesive layer on the substrate layer, on a surface opposite side to the image layer.

27. The method for producing a decorative sheet according to claim 26, wherein, in the image layer forming step, the thermal transfer image is formed by a sublimation type thermal transfer method.

28. The method for producing a decorative sheet according to claim 26, wherein, in the image layer forming step, the thermal transfer image is formed by a melting type thermal transfer method.

29. A method for producing a decorative article comprising:
a transfer sheet with a mold release member producing step of producing a transfer sheet with a mold release member including a mold release member, a mold releasing support, and a transfer layer in this order, and the transfer layer includes, in sequence form a mold releasing support side, a protective layer, an image layer including a thermal transfer image or a toner image, and a pressure-sensitive adhesive layer, by the method for producing a transfer sheet according to claim 22;
a peeling step of obtaining a transfer sheet by peeling the mold release member off from the transfer sheet with a mold release member;
an integrating step of integrating the transfer sheet and a decorative object by placing so that a surface of the pressure-sensitive adhesive layer of the transfer sheet and the decorative object are facing each other; and
after the integrating step, a transferring step of peeling the mold releasing support off from the transfer sheet.

30. A method for producing a decorative article comprising:
a decorative sheet producing step of producing a decorative sheet including a pressure-sensitive adhesive layer, a substrate layer, an image layer including a thermal transfer image or a toner image, and a protective layer in this order, by the method for producing a decorative sheet according to claim 26; and
an integrating step of integrating the decorative sheet and a decorative object by placing so that a surface of the pressure-sensitive adhesive layer of the decorative sheet and the decorative object are facing each other.

31. The method for producing a decorative article according to claim 29 comprising, after the integrating step, a curing step of curing the protective layer.

32. The method for producing a decorative article according to claim 31, wherein the pressure-sensitive adhesive layer is cured in the curing step.
